(19) United States
(12) Patent Application Publication
(10) Pub. No.: US 2017/0249547 A1
(43) Pub. Date: Aug. 31, 2017

(54) Systems and Methods for Holistic Extraction of Features from Neural Networks

(71) Applicant: The Board of Trustees of the Leland Stanford Junior University, Stanford, CA (US)

(72) Inventors: Avanti Shrikumar, Menlo Park, CA (US); Peyton Greis Greenside, Stanford, CA (US); Anshul Kundaje, Palo Alto, CA (US)

(73) Assignee: The Board of Trustees of the Leland Stanford Junior University, Stanford, CA (US)

(21) Appl. No.: 15/444,258

(22) Filed: Feb. 27, 2017

Related U.S. Application Data
(60) Provisional application No. 62/464,241, filed on Feb. 27, 2017.
(60) Provisional application No. 62/463,444, filed on Feb. 24, 2017.
(60) Provisional application No. 62/331,325, filed on May 3, 2016.
(60) Provisional application No. 62/300,726, filed on Feb. 26, 2016.

(51) Int. Cl. G06N 3/04; G06N 3/08

(52) U.S. Cl. CPC G06N 3/04; G06N 3/084

(57) ABSTRACT

Systems and methods in accordance with embodiments of the invention enable identifying informative features within input data using a neural network data structure. One embodiment includes a data structure describing a neural network that comprises a plurality of neurons; wherein the processor is configured by the feature application to: determine contributions of individual neurons to activation of a target neuron by comparing activations of a set of neurons to their reference values, where the contributions are computed by dynamically backpropagating an importance signal through the data structure describing the neural network; extracting aggregated features detected by the target neuron by: segmenting the determined contributions; clustering into clusters of similar segments; aggregating data to identify aggregated features of input data that contribute to the activation of the target neuron; and displaying aggregated features of input data to highlight important features.

### CROSS-REFERENCE TO RELATED APPLICATIONS

The present invention claims priority to U.S. Provisional Patent Application Ser. No. 62/300,726 entitled “Systems and Methods for Holistic Extraction of Features from Neural Networks” to Kundaje et al., filed Feb. 26, 2016, U.S. Provisional Patent Application Ser. No. 62/331,325 entitled “Systems and Methods for Holistic Extraction of Features from Neural Networks” to Shrikumar et al., filed May 3, 2016. U.S. Provisional Patent Application Ser. No. 62/463,444 entitled “Systems and Methods for Holistic Extraction of Features from Neural Networks” to Shrikumar et al., filed Feb. 24, 2017, and U.S. Provisional Patent Application Ser. No. 62/464,241 entitled “Interpretable Deep Learning Approaches to Decipher Context-specific Encoding of Regulatory DNA Sequences” to Shrikumar et al., filed Feb. 27, 2017. The disclosure of U.S. Provisional Patent Application Ser. No. 62/300,726, U.S. Provisional Patent Application Ser. No. 62/331,325, U.S. Provisional Patent Application Ser. No. 62/463,444, and U.S. Provisional Patent Application Ser. No. 62/464,241 are herein incorporated by reference in their entirety.

### STATEMENT OF FEDERALLY SPONSORED RESEARCH

This invention was made with government support under R01ES02500902 awarded by the National Institute of Health. The government has certain rights in the invention.

### FIELD OF THE INVENTION

The present invention generally relates to neural networks and more specifically relates to systems to extract features from neural networks.

### BACKGROUND

Neural networks are computational systems designed to solve problems in a manner similar to a biological brain. The fundamental unit of a neural network is an artificial neuron (also referred to as a neuron), modeled after a biological neuron. The number of neurons, and the various connections between those neurons can determine the type of neural network.

Neural networks can have one or more hidden layers which connect the input layer to the output layer. Patterns, such as (but not limited to) images, sounds, bit sequences, and/or genomic sequences can be fed into the neural network at an input layer of neurons. An input layer of neurons can include one or more neurons that feed input data into a hidden layer. The actual processing of the neural network is done in the hidden layer(s) by using weighted connections. These weights can be modified as the neural network learns in response to new inputs. Hidden layers in the neural network connect to an output layer, which can generate the answer to the problem solved by the neural network.

Neural networks can use supervised learning methods, where the network is presented with training data which includes an input and a desired output. Supervised learning methods can compare the output actually produced when the input is fed through the network with the desired output for that input from the network, and can slightly change the weights within the hidden layers such that the network is closer to generating the desired output.

Simple neural networks can include only a few neurons. More complex neural networks contain many neurons which can be organized into a variety of layers including an input layer, one or more hidden layers, and an output layer. Neural networks have been applied to solve a variety of problems including (but not limited to) regression analysis, pattern classification, data processing, and/or robotics applications.

### SUMMARY OF THE INVENTION

Systems and methods in accordance with embodiments of the invention enable identifying informative features within input data using a neural network data structure. One embodiment includes a network interface; a processor, and; a memory, containing: a feature application; a data structure describing a neural network that comprises a plurality of neurons: wherein the processor is configured by the feature application to: determine contributions of individual neurons to activation of a target neuron by comparing activations of a set of neurons to their reference values, where the contributions are computed by dynamically backpropagating an importance signal through the data structure describing the neural network; extracting aggregated features detected by the target neuron by: segmenting the determined contributions to the target neuron; clustering the segmented contributions into clusters of similar segments; aggregating data within clusters of similar segments to identify aggregated features of input data that contribute to the activation of the target neuron; and displaying the aggregated features of input data to highlight important features of the input data relied upon by the neural network.

In a further embodiment, the activation of the target neuron and the activations of the reference neurons are calculated by a rectified linear unit activation function.

In another embodiment, the reference input is predetermined.

In a still further embodiment, segmenting the determined contributions further comprises identifying segments with a highest value.

In still another embodiment, the processor is further configured to extract aggregated features by: filtering and discarding determined contributions with the significant score below the highest value.

In a yet further embodiment, the processor is further configured to extract aggregated features by: augmenting the determined contributions with a set of auxiliary information.

In yet another embodiment, the processor is further configured to extract aggregated features by: trimming aggregated features of the target neuron.

In a further embodiment again, the processor is further configured to extract aggregated features by: refining clusters based on the aggregated features of the target neuron.

In another embodiment again, the memory further contains input data and comprises a plurality of examples; and the processor is further configured by the feature application to identify examples from the input data in which the aggregated features are present.

### BRIEF DESCRIPTION OF THE DRAWINGS

FIG. 1A is a diagram conceptually illustrating a 2D image of horizontal and vertical lines including various features.

FIG. 1B is a diagram conceptually illustrating a 2D image of horizontal and vertical lines with various features highlighted.

FIG. 2 is a diagram conceptually illustrating computers and wireless devices using neural network feature controllers connected to a network in accordance to an embodiment of the invention.

FIG. 3 is a block diagram of a neural network feature controller in accordance with an embodiment of the invention.

FIG. 4 is a flow chart illustrating an overview for a process for feature identification for neural networks in accordance with an embodiment of the invention.

FIG. 5 is a flow chart illustrating a process to assign contribution score values to neurons in a neural network in accordance with an embodiment of the invention.

FIG. 6 is a diagram illustrating a neural network with two inputs and a Rectified Linear Units activation function which can utilize a DeepLIFT process to generate contribution score values in accordance with an embodiment of the invention.

FIG. 7 is a diagram illustrating a DeepLIFT process applied to the Tiny ImageNet dataset in accordance with an embodiment of the invention.

FIG. 8 is a diagram illustrating a DeepLIFT process compared to other backpropagation based approaches applied to a digit classification dataset in accordance with an embodiment of the invention.

FIGS. 9A and 9B are diagrams illustrating a DeepLIFT process compared to other approaches applied to a sample genomics dataset in accordance with an embodiment of the invention.

FIGS. 10A and 10B is a diagram illustrating importance scores in a DeepLIFT process for a genomics dataset in accordance with an embodiment of the invention.

FIG. 11 is a flowchart illustrating a process to extract features from contribution scores in a neural network in accordance with an embodiment of the invention.

FIG. 12A is a diagram illustrating aggregated multipliers identified in a genomics dataset by a holistic feature extraction process in accordance with an embodiment of the invention.

FIG. 12B is a diagram illustrating patterns identified in a genomics dataset by ENCODE.

FIG. 12C is a diagram illustrating patterns identified in a genomics dataset by HOMER.

FIG. 13 is a graph illustrating the comparison of various feature identification processes on a genomic sequence including features identified using a holistic feature extraction process in accordance with an embodiment of the invention.

FIG. 14 is a diagram illustrating dependencies between inputs between simulated interaction detection processes on a genomics dataset in accordance with an embodiment of the invention.

FIG. 15 is a diagram illustrating conditional references for a recurrent neural network in accordance with an embodiment of the invention.

FIG. 16 is a diagram illustrating conditional references applied to genomic data in accordance with an embodiment of the invention.

### DETAILED DESCRIPTION

Turning now to the drawings, systems and methods for extracting feature information in a computationally efficient manner from neural networks in accordance with embodiments of the invention are illustrated. Neural networks generally involve interconnected neurons (or nodes) which contain an activation function. Activation functions generate a predefined output in response to an input and/or a set of inputs. Weights applied to the interconnections between neurons and/or parameters of the activation functions can be determined during a training process, in which the weights and/or parameters of the activation functions are modified to produce a desired set of outputs for a given set of inputs.

Features are measurable properties found in machine learning and/or pattern recognition applications. As an illustrative example, lines are identifiable features in a 2D image. Neural networks are commonly applied in so called black box situations in which the features of the inputs that are relevant to the generation of the desired outputs are unknown. Systems and methods in accordance with various embodiments of the invention build neural networks in a computationally efficient manner that provide information regarding features of inputs that contribute to the ability of the neural network to generate the correct outputs. For example, the features of an image that enable a neural network to correctly classify the content of the image or the motifs within genomic data that promote protein binding. Furthermore, systems and methods in accordance with many embodiments of the invention can extract similar information concerning important features within input data from existing neural networks and can enable determinations of the importance of specific features with respect to generation of particular outputs. In this way, various embodiments of the invention can be broadly applicable in the extraction of insights from neural networks that have otherwise been regarded as black boxes predictors.

In a number of embodiments, important features within input data are identified based upon a neural network designed to generate outputs based upon the input data. In various embodiments of the invention, a variety of neural network feature identification processes can be used to identify important features within input data including (but not limited to) Deep Learning ImporTant Features (DeepLIFT) processes, holistic feature extraction processes, feature location identification processes, interaction detection processes, weight reparameterization processes, and/or incorporating prior knowledge of features. In several embodiments, DeepLIFT processes can assigning scores to neurons to unlock otherwise hidden information within the neural network. In certain embodiments, a contribution score is calculated by leveraging information about the difference between the activation of each neuron and a reference activation. This reference activation can be determined using domain specific knowledge. In many embodiments, DeepLIFT processes can calculate a signal even when a gradient based approach would similarly calculate a zero value.

Holistic feature extraction processes can aggregate features in neural networks using the scores of individual neurons. These importance scores can be found using a DeepLIFT process and/or through other methods, including but not limited to importance scores obtained through perturbation-based approaches such as in-silico mutagenesis or other machine learning methods such as support vector machines. In various embodiments, feature location identification processes can take aggregated features and identify them in another set of inputs. These aggregated features can be identified through holistic feature extraction processes and/or through alternative methods. Additionally, weight reparamaterization processes can be used to generate a rough picture of how a particular neuron within the neural network will respond to different inputs. Furthermore, in many embodiments of the invention, prior knowledge of features such as (but not limited to) which features should be important can be used in conjunction with an importance scoring method to encourage the network to place importance on features that prior knowledge suggests should be important. An illustrative example of features in a 2D image are discussed below.

### Features

In machine learning and pattern recognition applications, features are often thought to be an individual measurable property of a phenomenon being observed. Features are not limited to neural networks and can be extracted from (but not limited to) classifiers and/or detectors utilized in any of a variety of applications including (but not limited to) character recognition applications, speech recognition applications, and/or computer vision applications. 2D images can provide an illustrative example of features that can be relied upon to detect and/or classify content visible within an image.

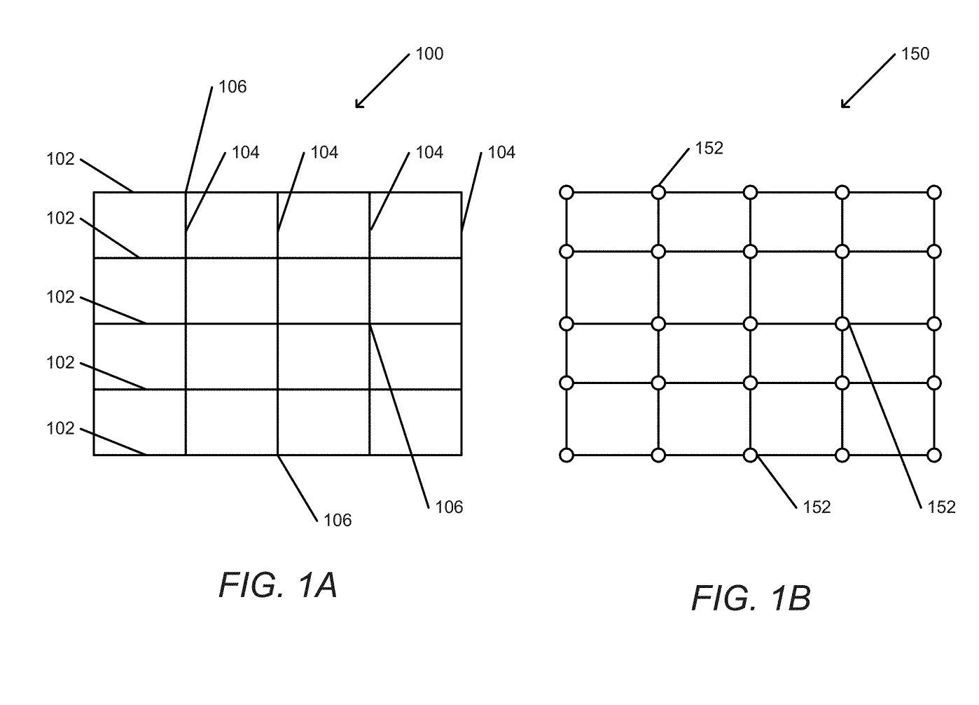

Features in a 2D image are conceptually illustrated in FIGS. 1A and 1B. An image 100 is illustrated in FIG. 1A. Image 100 contains horizontal lines 102, vertical lines 104, and the intersection of these lines 106. In some embodiments of the invention, horizontal and/or vertical lines, and/or the intersection of lines are features which can be identified within the image. The same image with various features highlighted is illustrated in FIG. 1B. An image 150 contains the same horizontal lines, vertical lines, and intersection of these lines as image 100. In this illustrative example, the intersection of several of these lines has been highlighted as feature 152. It should be readily apparent to one having ordinary skill in the art that many features can be found in a 2D image including (but not limited to) the horizontal and/or vertical lines themselves, corners, and/or other intersections of lines.

As can readily be appreciated, the features illustrated in FIGS. 1A and 1B are merely an illustrative example and many types of features can be extracted as appropriate to specific neural network applications. Before discussing the specifics of the processes utilized to perform holistic feature extraction from neural networks, an overview of the computing platform and software architectures that can be utilized to implement holistic feature extraction systems in accordance with many embodiments of the invention will be provided. Neural network feature controller architectures, including software architectures that can be utilized in holistic feature extraction, are discussed below.

### Neural Network Feature Controller Architectures

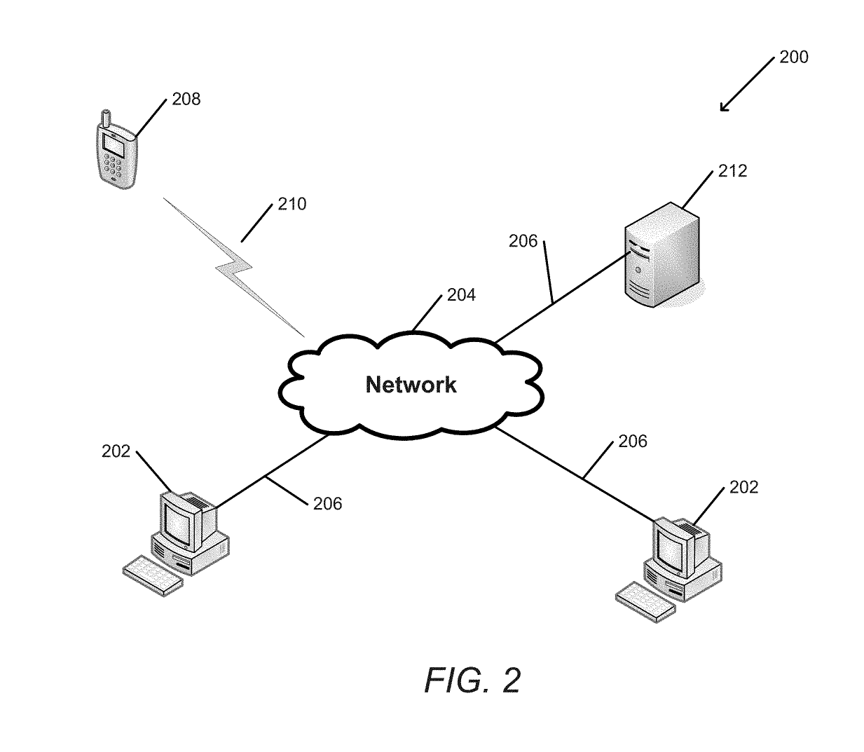

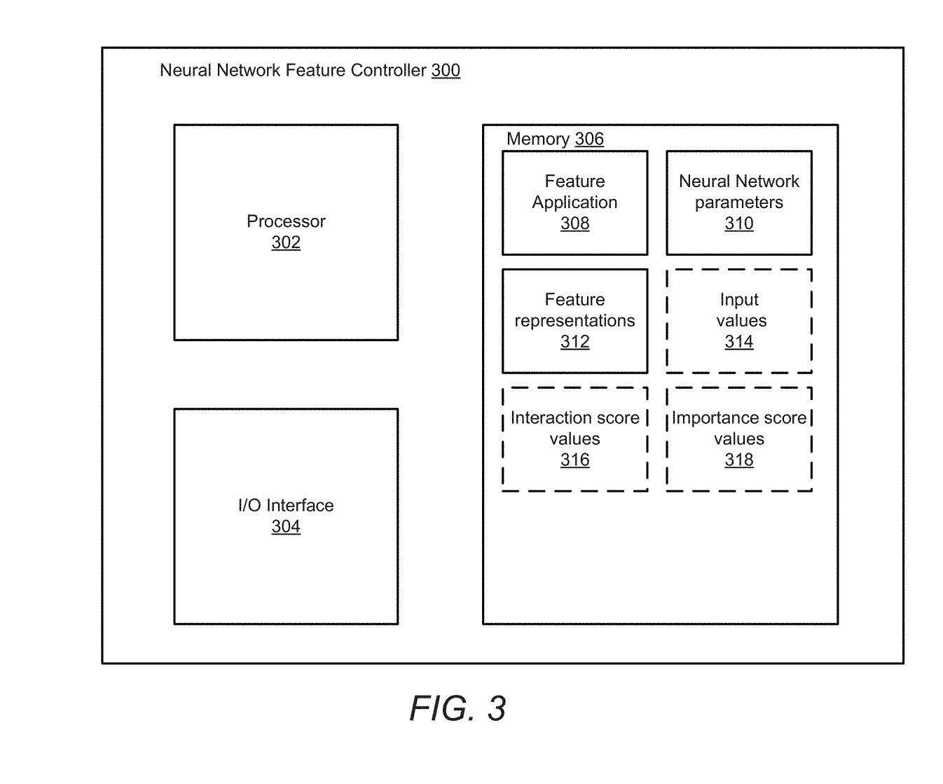

Computers and/or wireless devices using neural network feature controllers connected to a network in accordance to an embodiment of the invention are shown in FIG. 2. One or more computers 202 can connect to network 204 via a wired and/or wireless connection 206. In some embodiments of the invention, wireless device 208 can connect to network 204 via wireless connection 210. Wireless devices can include (but are not limited to) cellular telephones and/or tablet computers. Additionally, in many embodiments a database management system 212 can be connected to the network to track neural network and/or feature data which, for example, may be used to historically track how the importance of features change over time as the neural network is further trained. Although many systems are described above with reference to FIG. 2, any of a variety of systems can be utilized to connect neural network feature controllers to a network as appropriate to the requirements of specific applications in accordance with various embodiments of the invention. Neural network feature controllers in accordance with various embodiments of the invention are discussed below.

A neural network feature controller in accordance with an embodiment of the invention is shown in FIG. 3. In many embodiments, neural network feature controller 300 can calculate the importance of features within a neural network. The neural network feature controller includes at least one processor 302, an I/O interface 304, and memory 306. The at least one processor 302, when configured by software stored in memory, can perform calculations on and make changes to data passing through the I/O interface as well as data stored in memory. In several embodiments, the memory 306 includes software including (but not limited to) neural network feature application 308, neural network parameters 310, feature representations 312, as well as any one or more of: input values 314, interaction score values 316, and/or importance score values 318. In many embodiments, neural network feature applications can perform a variety of neural network feature processes which will be discussed in detail below, and can enable the system to perform calculations on the neural network parameters 310 to, for example (but not limited to), identify and/or aggregate feature representations 312.

In some embodiments, neural network parameters 314 can include (but are not limited to) the type of neural network, the total number of layers, the number of neurons in the input layer, the number of hidden layers, the number of neurons in each hidden layer, the number of neurons in the output layer, the activation function each neuron uses, and/or the weighted connections between neurons in the hidden layer(s). A variety of types of neural networks can be utilized including (but not limited to) feedforward neural networks, recurrent neural networks, time delay neural networks, convolutional neural networks, and/or regulatory feedback neural networks. Similarly, in various embodiments, a variety of activation functions can be utilized including (but not limited to) identity, binary step, soft step, tan h, arctan, softsign, rectified linear unit (ReLU), leaky rectified linear unit, parameteric rectified linear unit, randomized leaky rectified linear unit, exponential linear unit, s-shaped rectified linear activation unit, adaptive piecewise linear, softplus, bent identity, softexponential, sinusoid, sinc, gaussian, softmax, maxout, and/or a combination of activation functions. It should be readily apparent that neural networks are highly adaptable and can be adjusted as needed to fit the needs of specific embodiments of the invention.

Input values 314 can include (but are not limited to) as set of input data a feature identification process can find identified features in. Feature identification processes are discussed below. In some embodiments, interaction score values can include (but are not limited to) changes made to specific neurons in a neural network and/or interactions between neurons in a neural network. Although a number of different neural network feature controller implementations are described above with respect to FIG. 3, any of a variety of computing systems can be utilized to control the identification and/or use of features from neural networks as appropriate to the requirements of specific applications in accordance with various embodiments of the invention. An overview of identifying and using features in a neural network is discussed below.

### Neural Network Feature Identification Processes

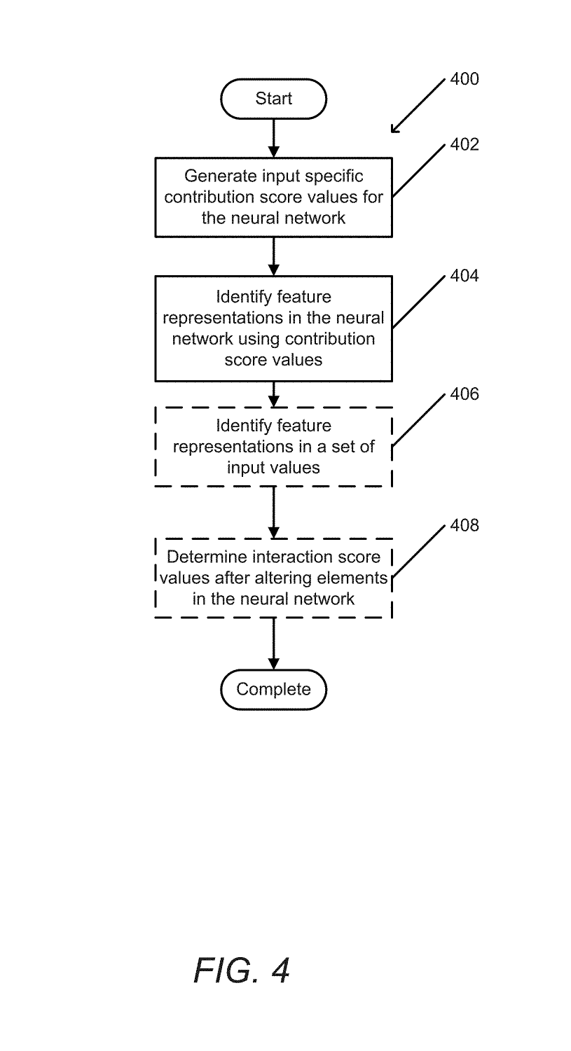

An overview of feature identification processes for neural networks in accordance with many embodiments of the invention are illustrated in FIG. 4. Input-specific contribution score values can be generated (402) for the neural network. In many embodiments of the invention, contribution score values can be generated (but are not limited to) using DeepLIFT processes. DeepLIFT processes are discussed below. Feature representations can be identified (404) using contribution score values. Processes for identification of feature representations will be discussed below.

In several embodiments of the invention, identified feature representations can optionally be utilized in many ways. Feature representations can be identified (406) in a set of input values (the features can be identified in a set of inputs that need not be constrained to be the same dimensions as what is supplied to the network). Identifying feature representations in a set of inputs is discussed below. Additionally, elements within the neural network can be changed and interaction score values can be determined (408). In many embodiments of the invention, interaction score values can include (but are not limited to) information regarding interactions between different neurons within the neural network and can be an input-specific interaction. Interaction score values are discussed below.

Although many different neural network feature identification processes are described above with reference to FIG. 4, any of a variety of processes to extract features from and/or use feature information from neural networks can be utilized as appropriate to the requirements of specific applications in accordance with embodiments of the invention. Before discussing each of the specific processes referenced above related to interaction detection, weight reparameterization, and importance scoring, the use of DeepLIFT and holistic feature extraction processes for feature identification and determining feature contribution are discussed in detail with respect to several different types of input data.

### DeepLIFT Processes

DeepLIFT processes in accordance with several embodiments of the invention can assign contribution score values to the neurons of a neural network. Contribution score values can be assigned by comparing the activation of a neuron in the neural network with its reference activation. In certain embodiments of the invention, the reference activation can be chosen as appropriate for specific applications. In many embodiments of the invention, this can generate a non-zero contribution score values even in situations where a gradient based approach generates a zero value.

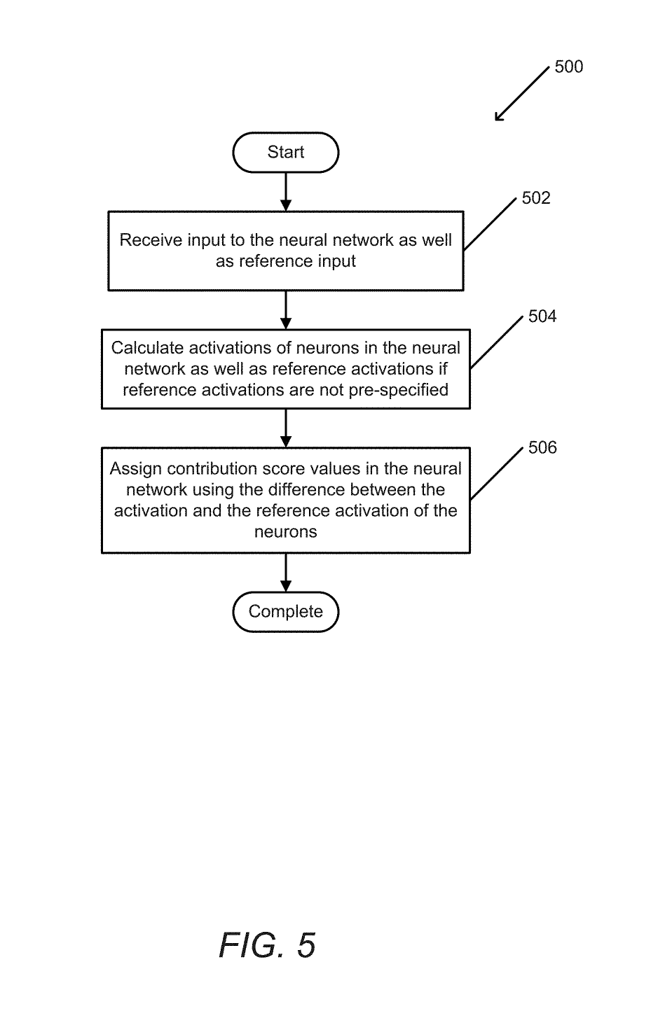

A DeepLIFT process in accordance with an embodiment of the invention illustrated in FIG. 5. In the illustrated process, input quantities and (optionally) reference input quantities as well as reference input can be received (502) by the neural network. The activation of neurons as well as reference activation are not pre-specified in the neural network can be calculated (504). In some embodiments, these activations can be calculated using a wide variety of activation functions including (but not limited to) identity, binary step, soft step, tan h, arctan, softsign, rectified linear unit (ReLU), leaky rectified linear unit, parameteric rectified linear unit, randomized leaky rectified linear unit, exponential linear unit, s-shaped rectified linear activation unit, adaptive piecewise linear, softplus, bent identity, softexponential, sinusoid, sinc, gaussian, softmax, maxout, and/or a combination of activation functions.

Reference activations can be calculated for neurons in the neural network by inputting a reference input into the neural network and computing the activations on this reference input. The choice of a reference input can rely on domain specific knowledge. In some embodiments, “what am I interested in measuring differences against?” can be asked as a guiding principle. If the inputs are mean-normalized, a reference input of all zeros may be informative. For genomic sequences, a reference input equal to average of all one-hot encoded sequence from the negative set can be utilized. Additional possible choices of a reference input are discussed below.

Contribution score values can be assigned (506) to neurons in the neural network by calculating the difference between the activation and the reference activation. The calculation of contribution score values will be discussed in detail below. Although several different processes for assigning contribution score values to a neural network are described above with reference to FIG. 5, any of a variety of processes can be used to compare the activation of each neuron to a reference activation within a neural network as appropriate to the requirements of specific applications in accordance with embodiments of the invention. The calculation and assignment of contribution score values using DeepLIFT processes is discussed below.

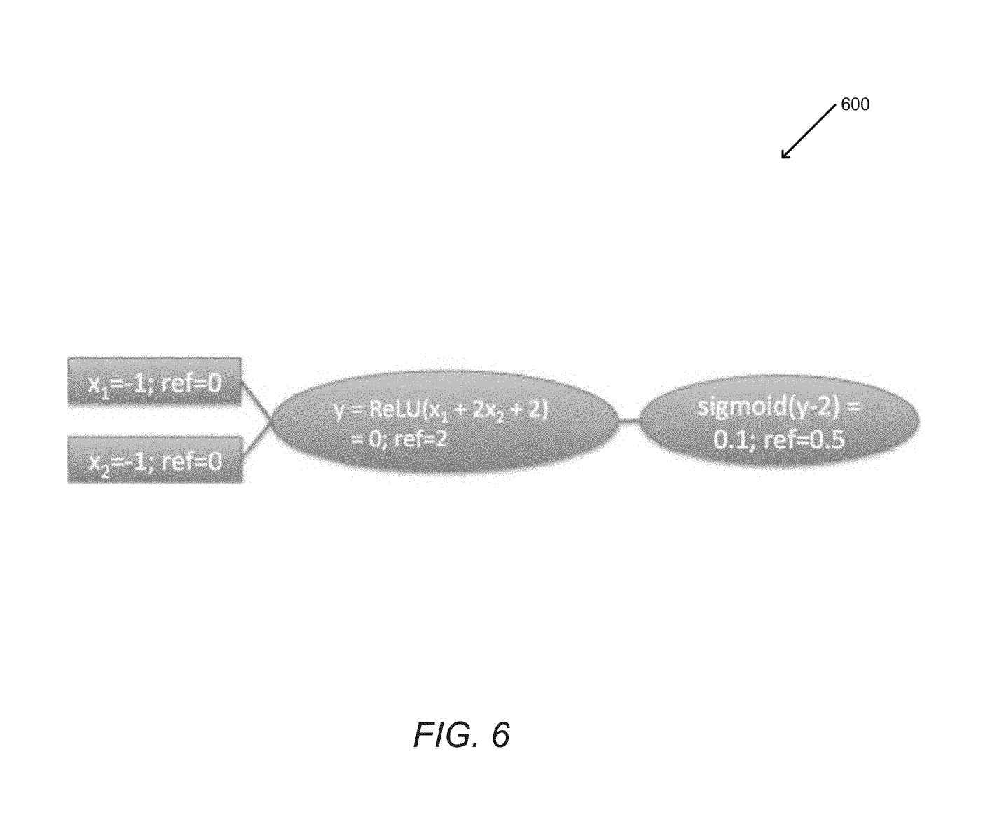

In accordance with some embodiments of the invention. DeepLIFT processes can be used to assign contribution score values to neurons in a neural network. As an illustrative example, FIG. 6 illustrates a simple neural network with inputs x₁ and x₂ that have reference values of 0. When x₁=x₂=−1, output is 0.1 but the gradients with respect to x₁ and x₂ are 0 due to the inactive activation function (here Rectified Linear Units) y which has activation of 2 under reference input. By comparing activations to their reference values, DeepLIFT can assign contributions to the output of ((0.1−0.5)⅓) to x₁ and ((0.1−0.5)⅔) to x₂.

In many embodiments, DeepLIFT processes can explain the difference in output from some ‘reference’ output in terms of the difference of the input from some ‘reference’ input. The ‘reference’ input represents some default or ‘neutral’ input that is chosen according to what is appropriate for the problem at hand. In some embodiments, t can represent some target output neuron of interest and x₁, x₂, . . . , xₙ can represent some neurons in some intermediate layer or set of layers that are necessary and sufficient to compute t. t⁰ can represent the reference activation of t. WΔt can be defined as the difference-from-reference, that is Δt=t−t⁰. DeepLIFT processes can assign contribution score values C_{Δx}_{ᵢ}_{Δt} to Δxᵢ s.t.:

$${\sum }_{i = 1}^{n} {C}_{Δ {x}_{i} Δ t} = Δ t \qquad ( 1 )$$

Eq. 1 can be called the summation-to-delta property. C_{Δx}_{ᵢ}_{Δt} can be thought of as the amount of difference-from-reference in t that is attributed to or ‘blamed’ on the difference-from-reference of xᵢ. Note that when a neuron's transfer function is well-behaved, the output is locally linear in its inputs, providing additional motivation for Eq. 1.

C_{Δx}_{ᵢ}_{Δt} can be non-zero even when

$$\frac{\partial t}{\partial {x}_{i}}$$

is zero. In various embodiments, this can allow DeepLIFT processes to address a fundamental limitation of gradients because a neuron can be signaling meaningful information even in the regime where its gradient is zero. Another drawback of gradients addressed by DeepLIFT is that the discontinuous nature of gradients can cause sudden jumps in the importance score over infinitesimal changes in the input. By contrast, the difference-from-reference is continuous, allowing DeepLIFT to avoid discontinuities, such as those caused by the bias term of a ReLU.

Multipliers and Chain Rule:

In various embodiments, for a given input neuron x with difference-from-reference Δx, and target neuron t with difference-from-reference Δt that the contribution is wished to be computed for, the multiplier m_{ΔxΔt} can be defined as:

$${m}_{Δ x Δ t} = \frac{{C}_{Δ x Δ t}}{Δ x} \qquad ( 2 )$$

In other words, the multiplier m_{ΔxΔt} can be the contribution of Δx to Δt divided by Δx. Note the close analogy to the idea of partial derivatives: the partial derivative

$$\frac{\partial t}{\partial x}$$

is the infinitesimal change in t caused by an infinitesimal change in x, divided by the infinitesimal change in x. The multiplier is similar in spirit to a partial derivative, but over finite differences instead of infinitesimal ones.

The Chain Rule for Multipliers:

In some embodiments, an input layer can have neurons x₁, . . . , xₙ, a hidden layer with neurons y₁, . . . , yₙ, and some target output neuron z. Given values for m_{Δx}_{ᵢ}_{Δy}_{ⱼ} and m_{Δy}_{ⱼ}_{Δz}, the following definition of m_{Δx}_{ᵢ}_{Δz} is consistent with the summation-to-delta property in Eq. 1:

$${m}_{Δ {x}_{i} Δ z} = {\sum }_{j} {m}_{Δ {x}_{i} Δ {y}_{j}} {m}_{Δ {y}_{j} Δ z} \qquad ( 3 )$$

Eq. 3 can be referred to as the chain rule for multipliers. Given the multipliers for each neuron to its immediate successors, the multipliers can be computed for any neuron to a given target neuron efficiently via backpropagation—analogous to how the chain rule for partial derivatives allows us to compute the gradient w.r.t. the output via backpropagation.

Defining the Reference:

When formulating the DeepLIFT processes in accordance with some embodiments, the reference of a neuron is its activation on the reference input. Formally, a neuron x can have inputs i₁, i₂, . . . such that x=f(i₁,i₂, . . . ). Given the reference activations i₁⁰, i₂⁰, . . . of the inputs, the reference activation x⁰ of the output can be calculated as:

x⁰=f(i₁⁰,i₂⁰, . . . ) (4)

i.e. references for all neurons can be found by choosing a reference input and propagating activations through the net.

The choice of a reference input can be critical for obtaining insightful results from DeepLIFT processes. In practice, choosing a good reference would rely on domain-specific knowledge, and in some cases it may be best to compute DeepLIFT scores against multiple different references. As a guiding principle, one can ask “what am I interested in measuring differences against?”. For MNIST, a reference input of all-zeros can be used as this is the background of the images. For the binary classification tasks on DNA sequence inputs (strings over the alphabet {A,C,G,T}), sensible results can be obtained using either a reference input containing the expected frequencies of ACGT in the background, or by averaging the results over multiple reference inputs for each sequence that are generated by shuffling each original sequence. When shuffling the original sequence, a variety of shuffling functions can be used including but not limited to a random shuffling or a dinucleotide shuffling, where a dinucleotide shuffling is a shuffling strategy that preserves the counts of dinucleotides. The variance in importance scores across different reference values generated through such shuffling can also be informative in identifying, isolating and removing noise in importance scores.

It is important to note that gradient×input implicitly uses a reference of all-zeros (it is equivalent to a first-order Taylor approximation of gradient×Δinput where Δ is measured w.r.t. an input of zeros). Similarly, integrated gradients requires the user to specify a starting point for the integral, which is conceptually similar to specifying a reference for DeepLIFT. While Guided Backprop and pure gradients don't use a reference, this can be considered a limitation as these methods only describe the local behaviour of the output at the specific input value, without considering how the output behaves over a range of inputs.

Separating Positive and Negative Contributions:

In several embodiments, it can be essential to treat positive and negative contributions differently. To do this, for every neuron xᵢ, Δxᵢ⁺ and Δxᵢ⁻ can be introduced to represent the positive and negative components of Δxᵢ, such that:

Δxᵢ=Δxᵢ⁺+Δxᵢ⁻

C_{Δx}_{ᵢ}_{Δt}=C_{Δx}_{ᵢ}_{⁺}_{Δt}+C_{Δx}_{ᵢ}_{^{−}}_{Δt}

It will be shown below that m_{Δx}_{ᵢ}_{⁺}_{Δt} and m_{Δx}_{ᵢ}_{^{−}}_{Δt} may be different when discussing the RevealCancel rule, but for the Linear rule and the Rescale rule m_{Δx}_{ᵢ}_{Δt}=m_{Δx}_{ᵢ}_{⁺}_{Δt}=m_{Δx}_{ᵢ}_{^{−}}_{Δt}.

Assigning Contribution Scores:

In several embodiments of the invention, a series of rules have been formulated to help assign contribution scores for each neuron to its immediate input which can include (but are not limited to) the linear rule, the Rescale rule, and/or the RevealCancel rule. However, it should be readily apparent that the assignment of contribution scores are not limited to only these rules and can be otherwise assigned in accordance with many embodiments of the invention. In conjunction with the chain rule for multipliers, these rules can be used to find the contributions of any input (not just the immediate inputs) to a target output via backpropagation.

The Linear Rule:

In many embodiments, the linear rule can apply to (but is not limited to) Dense and Convolutional layers (but generally excludes nonlinearities). y can be a linear function of its inputs xᵢ such that y=b+Σᵢ wᵢxᵢ, and further Δy=Σᵢ wᵢΔxᵢ. The positive and negative parts of Δy can be defined as:

$$\begin{matrix}Δ {y}^{+} = {\sum }_{i} 1 \{ {w}_{i} Δ {x}_{i} > 0 \} {w}_{i} Δ {x}_{i} \\ = {\sum }_{i} 1 \{ {w}_{i} Δ {x}_{i} > 0 \} {w}_{i} ( Δ {x}_{i}^{+} + Δ {x}_{i}^{-} ) \\ Δ {y}^{-} = {\sum }_{i} 1 \{ {w}_{i} Δ {x}_{i} < 0 \} {w}_{i} Δ {x}_{i} \\ = {\sum }_{i} 1 \{ {w}_{i} Δ {x}_{i} < 0 \} {w}_{i} ( Δ {x}_{i}^{+} + Δ {x}_{i}^{-} )\end{matrix}$$

Which leads to the following choice for the contributions:

C_{Δx}_{ᵢ}_{⁺}_{Δy}_{⁺}=1{wᵢΔxᵢ>0}wᵢΔxᵢ⁺

C_{Δx}_{ᵢ}_{^{−}}_{Δy}_{⁺}=1{wᵢΔxᵢ>0}wᵢΔxᵢ⁻

C_{Δx}_{ᵢ}_{⁺}_{Δy}_{^{−}}=1{wᵢΔxᵢ<0}wᵢΔxᵢ⁺

C_{Δx}_{ᵢ}_{^{−}}_{Δy}_{^{−}}=1{wᵢΔxᵢ<0}wᵢΔxᵢ⁻

Multipliers can then be found using the definition discussed above, which gives m_{Δx}_{ᵢ}_{⁺}_{Δy}_{⁺}=m_{Δx}_{ᵢ}_{^{−}}_{Δy}_{⁺}=m_{Δx}_{ᵢ}_{Δy}_{⁺}=1 {wᵢΔxᵢ>0}wᵢ and m_{Δx}_{ᵢ}_{⁺}_{Δy}_{^{−}}=m_{Δx}_{ᵢ}_{^{−}}_{Δy}_{^{−}}=m_{Δx}_{ᵢ}_{Δy}_{^{−}}=1 {wᵢΔxᵢ<0}wᵢ.

In several embodiments, Δxᵢ can equal 0. While setting multipliers to 0 in this case would be consistent with summation-to-delta, it is possible that Δxᵢ⁺ and Δxᵢ⁻ are nonzero (and cancel each other out), in which case setting the multiplier to 0 would fail to propagate importance to them. To avoid this, one possibility is to set m_{Δx}_{ᵢ}_{⁺}_{Δy}_{⁺}=m_{Δx}_{ᵢ}_{⁺}_{Δy}_{^{−}}=0.5wᵢ when Δxᵢ is 0 (similarly for Δx⁻)—however, other choices are also possible.

Computing Importance Scores for the Linear Rule Using Standard Neural Network Operations.

In several embodiments, the propagation of the multipliers for the Linear rule can be framed in terms of standard operations provided by GPU backends such as tensorflow and theano. As an illustrative example, consider Dense layers (also known as fully connected layers). Let W represent the tensor of weights, and let ΔX and ΔY represent a 2d matrix with dimensions sample×features such that ΔY=matrix_mul(W,ΔX). Here, matrix_mul is matrix multiplication. Let M_{ΔXΔt} and M_{ΔYΔt} represent tensors of multipliers (again with dimensions sample×features). Let · represent an elementwise product, and let 1 {condition} represent a binary matrix that is 1 where “condition” is true and 0 otherwise. It can be shown that:

M_{ΔXΔt}=(matrix_mul(W^{T}⊙1{W^{T}>0},M_{ΔY}_{⁺}_{Δt})⊙1{ΔX>0}

+matrix_mul(W^{T}⊙1{W^{T}<0},M_{ΔY}_{⁺}_{Δt})⊙1{ΔX<0})

+(matrix_mul(W^{T}⊙1{W^{T}>0},M_{ΔY}_{^{−}}_{Δt})⊙1{ΔX<0}

+matrix_mul(W^{T}⊙1{W^{T}<0},M_{ΔY}_{^{−}}_{Δt})⊙1{ΔX>0})

+matrix_mul(W^{T},0.5(M_{ΔY}_{⁺}_{Δt}+M_{ΔY}_{^{−}}_{Δt}))⊙1{ΔX=0})

As another illustrative example, consider Convolutional layers. Let W represent a tensor of convolutional weights such that ΔY=conv(W,ΔX), where conv represents the convolution operation. Let transposed_conv represent a transposed convolution (comparable to the gradient operation for a convolution) such that

$$\frac{d}{dt} X = transposed\_conv ( W , \frac{d}{dt} Y ) .$$

It can be shown that:

M_{ΔXΔt}=(transposed_conv(W⊙1{W>0},M_{ΔY}_{⁺}_{Δt})⊙1{ΔX>0}

+transposed_conv(W⊙1{W<0},M_{ΔY}_{⁺}_{Δt})⊙1{ΔX<0})

+(transposed_conv(W⊙1{W>0},M_{ΔY}_{^{−}}_{Δt})⊙1{ΔX<0}

+transposed_conv(W⊙1{W<0},M_{ΔY}_{^{−}}_{Δt})⊙1{ΔX>0})

+transposed_conv(W,0.5(M_{ΔY}_{⁺}_{Δt}+M_{ΔY}_{^{−}}_{Δt}))⊙1{ΔX=0})

Separated Linear Rule for Separate Treatment of Positive and Negative Terms:

In some embodiments, instead of defining Δy⁺=Σᵢ1{wᵢΔxᵢ>0}wᵢΔxᵢ and Δy⁻=Σᵢ1 {wᵢΔxᵢ<0}wᵢΔxᵢ the terms can be defined as Δy⁺=Σᵢ1{wᵢ>0}wᵢΔxᵢ⁺+1 {wᵢ<0}wᵢΔxᵢ⁻ and Δy⁻=Σᵢ1 {wᵢ<0}wᵢΔxᵢ⁺+1 {wᵢ>0}wᵢΔxᵢ⁻. This can result in m_{Δx}_{₊}_{Δy}_{⁺}=m_{Δx}_{^{−}}_{Δy}_{^{−}}=1 {wᵢ>0}wᵢ and m_{Δx}_{⁺}_{Δy}_{^{−}}=m_{Δx}_{^{−}}_{Δy}_{⁺}=1 {wᵢ<0}wᵢ.

The Rescale Rule:

In several embodiments, this rule can apply to nonlinear transformations that take a single input, such as the ReLU, tan h or sigmoid operations. Neuron y can be a nonlinear transformation of its input x such that y=f(x). Because y has only one input, by summation-to-delta one can have C_{ΔxΔy}=Δy, and consequently

$${m}_{Δ x Δ y} = \frac{Δ y}{Δ x} .$$

For the Rescale rule, Δy⁺ and Δy⁻ can be set proportional to Δx⁺ and Δx⁻ as follows:

$$\begin{matrix}Δ {y}^{+} = \frac{Δ y}{Δ x} Δ {x}^{+} = {C}_{Δ {x}^{+} Δ {y}^{+}} \\ Δ {y}^{-} = \frac{Δ y}{Δ x} Δ {x}^{-} = {C}_{Δ {x}^{-} Δ {y}^{-}}\end{matrix}$$

Based on this:

$${m}_{Δ {x}^{+} Δ {y}^{+}} = {m}_{Δ {x}^{-} Δ {y}^{-}} = {m}_{Δ x Δ y} = \frac{Δ y}{Δ x}$$

In many embodiments, in the case where x→x⁰, Δx→0 and Δy→0, the definition of the multiplier approaches the derivative, i.e.

$${m}_{Δ x Δ y} \to \frac{d y}{d x} ,$$

where the

$$\frac{d y}{d x}$$

is evaluated at x=x⁰. The gradient can thus be used instead of the multiplier when x is close to its reference to avoid numerical instability issues caused by having a small denominator. Note that the Rescale rule can address both saturation and the thresholding problems introduced by gradients (where the thresholding problem refers to discontinuities in the gradients including but not limited to those cased by using a bias term with a ReLU).

In many embodiments, there is a connection between DeepLIFT processes and Shapely values. Briefly, the Shapely values measure the average marginal effect of including an input over all possible orderings in which inputs can be included. If “including” an input is defined as setting it to its actual value instead of its reference value, DeepLIFT processes can be thought of as a fast approximation of the Shapely values.

The RevealCancel Rule: An Improved Approximation of the Shapley Values:

While the Rescale rule improves upon simply using gradients, there are still some situations where it can provide misleading results. Consider the operation o=min(i₁, i₂), computed as y=i₁−h₂ where h₂=max(0,h₁) and h₁=i₁−i₂. In the case where the reference values of i₁=0 and i₂=0, then using the Rescale rule, all importance would be assigned either to i₁ or to i₂ (whichever is smaller). This can obscure the fact that both inputs are relevant for the min operation.

To understand why this occurs, consider the case when i₁>i₂. In this case, h₁=(i₁−i₂) is >0 and h₂=max(0,h₁) is equal to h₁. By the Linear rule, it can be calculated that C_{Δi}_{₁}_{Δh}_{₁}=i₁ and C_{Δi}_{₂}_{Δh}_{₁}=−i₂. By the Rescale rule, the multiplier m_{Δh}_{₁}_{Δh}_{₂} is

$$\frac{Δ {h}_{2}}{Δ {h}_{1}} = 1 ,$$

and thus C_{Δi}_{₁}_{Δh}_{₂}=m_{Δh}_{₁}_{Δh}_{₂}C_{Δi}_{₁}_{Δh}_{₁}=i₁ and C_{Δi}_{₂}_{Δh}_{₂}=m_{Δh}_{₁}_{Δh}_{₂}C_{Δi}_{₂}_{Δh}_{₁}=−i₂. The total contribution of i₁ to the output o becomes (i₁−C_{Δi}_{₁}_{Δh}_{₂})=(i₁−i₁)=0, and the total contribution of i₂ to o is −C_{Δi}_{₂}_{Δh}_{₂}=i₂. This calculation is misleading as it discounts the fact that C_{Δi}_{₂}_{Δh}_{₂} would be 0 if i₁ were 0—in other words, it ignores a dependency induced between i₁ and i₂ that comes from i₂ canceling out i₁ in the nonlinear neuron h₂. A similar failure occurs when i₁<i₂; the Rescale rule results in C_{Δi}_{₁}_{Δo}=i₁ and C_{Δi}_{₂}_{Δo}=0. Note that gradients, gradient×input. Guided Backpropagation and integrated gradients would also assign all importance to either i₁ or i₂, because for any given input the gradient is zero for one of i₁ or i₂.

In several embodiments, a way to address this is by treating the positive and negative contributions separately. The nonlinear neuron y=f(x) can again be considered. Instead of assuming that Δy⁺ and Δy⁻ are proportional to Δx⁺ and Δx⁻ and that m_{Δx}_{⁺}_{Δy}_{⁺}=m_{Δx}_{^{−}}_{Δy}_{^{−}}=m_{ΔxΔy} (as is done for the Rescale rule), they can be defined as follows:

$$Δ {y}^{+} = \frac{1}{2} ( f ( {x}^{0} + Δ {x}^{+} ) - f ( {x}^{0} ) ) + \frac{1}{2} ( f ( {x}^{0} + Δ {x}^{-} + Δ {x}^{+} ) - f ( {x}^{0} + Δ {x}^{-} ) )$$

$$Δ {y}^{-} = \frac{1}{2} ( f ( {x}^{0} + Δ {x}^{-} ) - f ( {x}^{0} ) ) + \frac{1}{2} ( f ( {x}^{0} + Δ {x}^{+} + Δ {x}^{-} ) - f ( {x}^{0} + Δ {x}^{+} ) )$$

$${m}_{Δ {x}^{+} Δ {y}^{+}} = \frac{{C}_{Δ {x}^{+} {y}^{+}}}{Δ {x}^{+}} = \frac{Δ {y}^{+}}{Δ {x}^{+}} ; {m}_{Δ {x}^{-} Δ {y}^{-}} = \frac{Δ {y}^{-}}{Δ {x}^{-}}$$

In other words, Δy⁺ can be set to the average impact of Δx⁺ after no terms have been added and after Δx⁻ has been added, and Δy⁻ can be set to the average impact of Δx⁻ after no terms have been added and after Δx⁺ has been added. This can be thought of as the Shapely values of Δx⁺ and Δx⁻ contributing to y.

By considering the impact of the positive terms in the absence of negative terms, and the impact of negative terms in the absence of positive terms, some of the issues that arise from positive and negative terms canceling each other out can be alleviated.

In many embodiments, while the RevealCancel rule can also avoid saturation and thresholding pitfalls, there are some circumstances where the Rescale rule might be preferred. Specifically, consider a thresholded ReLU where Δy>0 iff Δx≧b. If Δx<b merely indicates noise, one would want to assign contributions of 0 to both Δx⁺ and Δx⁻ (as done by the Rescale rule) to mitigate the noise. RevealCancel may assign nonzero contributions by considering Δx⁺ in the absence of Δx⁻ and vice versa.

Element-Wise Products:

In many embodiments, consider:

y=x₁x₂=(x₁⁰+Δx₁)(x₂⁰+Δx₂) (5)

### Therefore:

$$\begin{matrix}Δ y = y - {y}^{0} \\ = ( {x}_{1}^{0} + Δ {x}_{1} ) ( {x}_{2}^{0} + Δ {x}_{2} ) - ( {x}_{1}^{0} {x}_{2}^{0} ) \\ = {x}_{1}^{0} Δ {x}_{2} + {x}_{2}^{0} Δ {x}_{1} + Δ x 1 Δ {x}_{2} \\ = Δ {x}_{1} ( {x}_{2}^{0} + \frac{Δ {x}_{2}}{2} ) + Δ {x}_{2} ( {x}_{1}^{0} + \frac{Δ {x}_{1}}{2} )\end{matrix} \qquad ( 6 )$$

Thus, viable choices for the multipliers can be m_{Δx}_{₁}_{Δy}=m_{Δx}_{₁}_{⁺}_{Δy}=m_{Δx}_{₁}_{^{−}}_{Δy}=x₂⁰+0.5Δx₂ and m_{Δx}_{₂}_{Δy}=x₁⁰+0.5Δx₁. In some embodiments, a rule that gives separate consideration to positive and negative contributions to Δy and Δx can similarly be formulated by substituting Δx=Δx⁺+Δx⁻ in the equation above.

Conditional References:

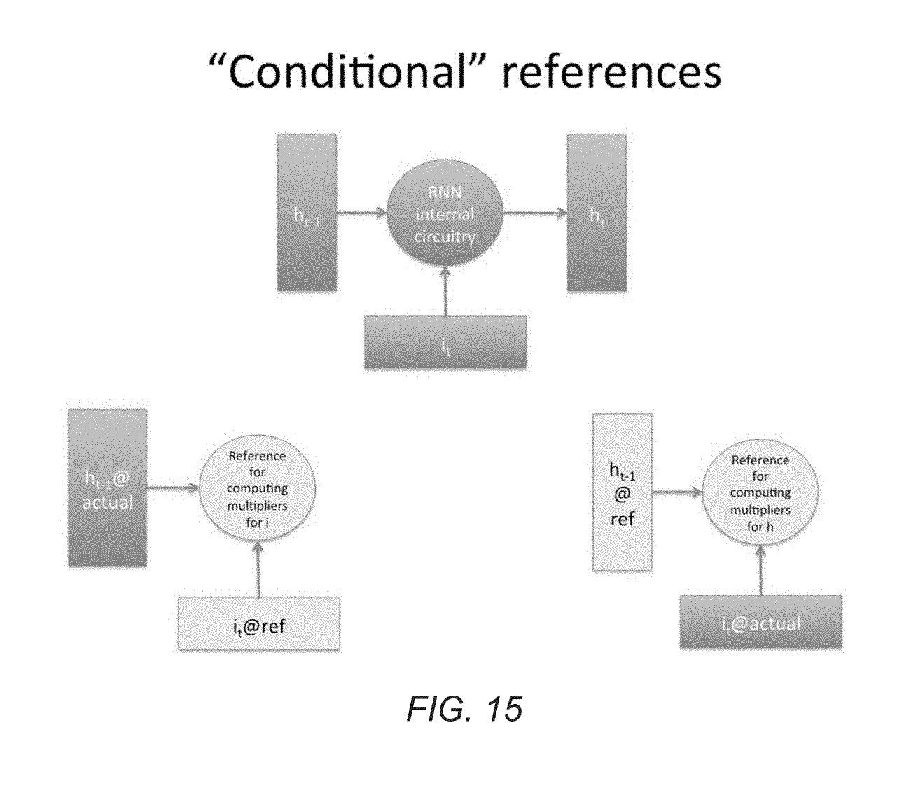

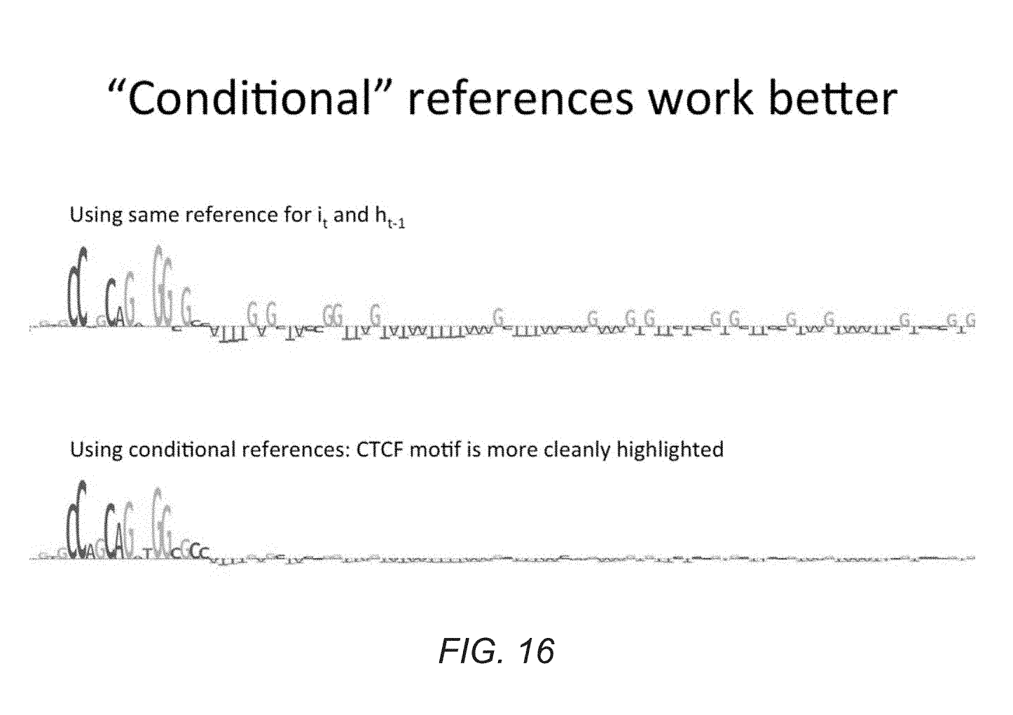

In some embodiments, when applying DeepLIFT processes to Recurrent Neural Networks it can be informative to use a slightly different reference when propagating information to inputs compared to propagating information to the previous hidden state. For example, consider the propagation of importance from the hidden state at time to to the inputs at time t and the hidden state at time t−1. When propagating importance from the hidden state at time t to the inputs at time t, the reference input at time t can be used while the hidden state at time t−1 is kept at its actual activation; in such an embodiment, any importance scores flowing to the input at time t can be thought of as “conditioned” on the actual hidden state at time t−1. Analogously, when propagating importance scores from the hidden state at time t to the hidden state at time t−1, the reference hidden state at time t−1 can be used while the input at time t is kept at its true value; thus, any importance scores flowing to the hidden state at time t−1 can be thought of as “conditioned” on the actual input received at time t. In some embodiments, importance scores obtained in this way can then be normalized to maintain the summation-to-delta property. Such approaches can be contrasted with using both the reference for the hidden state at time t−1 and the reference for the inputs at time t simultaneously when propagating importance to both the hidden state at time t−1 and the inputs at time t. FIG. 15 illustrates conditional references for Recurrent Neural Networks in accordance with an embodiment of the invention. FIG. 16 illustrates conditional references being applied to genomic data (below) compared to DeepLIFT processes applied to the same genomic data without conditional references (above).

Silencing Undesirable Sources of Variation:

In some embodiments, it may be useful to suppress differences in contribution scores stemming from specific sources of variation. For example, when running DeepLIFT processes on genomic sequence, it may be desirable to suppress differences in contribution scores that can arise from one shuffled version of a sequence to the next (where the shuffling approach can include but is not limited to a random shuffling or a dinucleotide-preserving shuffling). An example of an approach to address this is to empirically identify the variation in the activations of neurons in the network that arise from computing activations on different shuffled versions of a sequence, and to then suppress or mask differences-from-reference that occur sufficiently within this observed variation.

Weight Normalization for Constrained Inputs:

In many embodiments, y can be a neuron with some subset of inputs S_{y} that are constrained such that Σ_{xεS}_{_{y}} x=c (for example, one-hot encoded input satisfies the constraint Σ_{xεS}_{_{y}} x=1, and a convolutional neuron operating on one-hot encoded channels has one constraint per channel that it sees). Let the weights from x to y be denoted w_{xy} and let b_{y} be the bias of y. It is advisable to use normalized weights w̅_{xy}=w_{xy}−μ and bias b̅_{y}=b_{y}+cμ, where μ is the mean over all w_{xy} for which x εS_{y}. This can maintain the output of the neural net because, for any constant μ:

$$\begin{matrix}( {\sum }_{x ∈ {S}_{y}} x ( {w}_{xy} - μ ) ) + ( {b}_{y} + c μ ) = ( {\sum }_{x ∈ {S}_{y}} {xw}_{xy} ) - \\ ( \sum x μ ) + ( {b}_{y} + c μ ) \\ = ( {\sum }_{x ∈ {S}_{y}} {xw}_{xy} ) - c μ + ( {b}_{y} + c μ ) \\ = ( {\sum }_{x ∈ {S}_{y}} {xw}_{xy} ) + {b}_{y}\end{matrix} \qquad ( 7 )$$

This mean normalization can be repeated iteratively for every subset of inputs that satisfies the constraint—e.g. for every channel in a convolutional filter. The normalization can be desirable because, for affine functions, the multipliers m_{ΔxΔy} can be equal to the weights w_{xy} and can thus be sensitive to μ. To take the example of a convolutional neuron operating on one-hot encoded rows: by mean-normalizing w_{xy} for each channel in the filter, one can ensure that the contributions C_{ΔxΔy} from some channels are not systematically overestimated or underestimated relative to the contributions from other channels, particularly in the case where a reference of all zeros is chosen.

Choice of Target Layer:

In various embodiments, in the case of softmax or sigmoid outputs, it may be preferred to compute contributions to the linear layer preceding the final nonlinearity rather than the final nonlinearity itself. This can avoid an attenuation caused by the summation-to-delta property. For example, consider a sigmoid output o=σ(y), where y is the logit of the sigmoid function. Assume y=x₁+x₂, where x₁⁰=x₂⁰=0. When x₁=50 and x₂=0, the output o saturates at very close to 1 and the contributions of x₁ and x₂ are 0.5 and 0 respectively. However, when x₁=100 and x₂=100, the output o is still very close to 0, but the contributions of x₁ and x₂ are now both 0.25. This can be misleading when comparing scores across different inputs because a stronger contribution to the logit would not always translate into a higher DeepLIFT score. To avoid this, in some embodiments, contributions to y can be computed rather than o.

Adjustments for Softmax Layers:

If contributions to the linear layer preceding the softmax are computed rather than the softmax output, an issue that could arise is that the final softmax output involves a normalization over all classes, but the linear layer before the softmax does not. This can be addressed by normalizing the contributions to the linear layer by subtracting the mean contribution to all classes. Formally, if n is the number of classes. C_{ΔxΔc}_{ᵢ} represents the unnormalized contribution to class cᵢ in the linear layer and C′_{ΔxΔc}_{ᵢ} represents the normalized contribution:

$${C}_{Δ x Δ {c}_{i}}^{′} = {C}_{Δ x Δ {c}_{i}} - \frac{1}{n} {\sum }_{j = 1}^{n} {C}_{Δ x Δ {c}_{j}} \qquad ( 8 )$$

As a justification for this normalization, note that subtracting a fixed value from all the inputs to the softmax leaves the output of the softmax unchanged. Simulated results for using DeepLIFT processes are discussed below.
DeepLIFT Processes with Tiny ImageNet

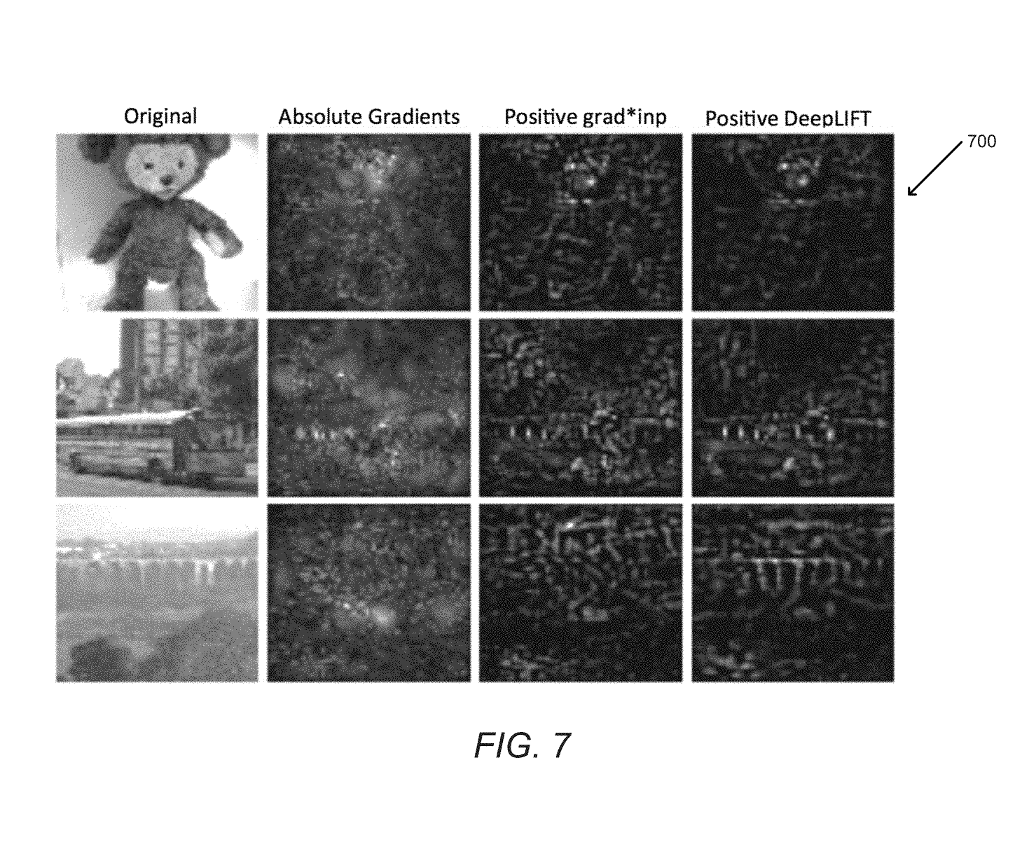

In accordance with several embodiments of the invention, a simulation of a DeepLIFT process (using the Rescale rule at nonlinearities) with VGG16 architecture was trained using the Keras framework on a scaled-down version of the Imagenet dataset, dubbed ‘Tiny Imagenet’. In the simulation, the images were 64×64 in dimension and belonged to one of 200 output classes. Simulated results shown in FIG. 7; the reference input was an input of all zeros after preprocessing. FIG. 7 illustrates importance scores for RBG channels summed to a per-pixel importance using different methods. From left to right: the original image, an absolute value of the gradient, a positive gradient*input, and a positive DeepLIFT.

### DeepLIFT Processes for Digit Classification

In accordance with an embodiment of the invention, a convolutional neural network can be trained using the MNIST database of handwritten digits. The architecture of the convolutional neural network consists of two convolutional layers, followed by a fully connected layer, followed by the output layer. Convolutions with stride>1 instead of pooling layers can be used. It should be readily apparent that this is merely an illustrative example, and other types of neural networks can be used and/or other values within the convolutional neural network can be used including (but not limited to) additional convolutional layers, different connectivity between the layers, and/or pooling methods. For DeepLIFT processes and integrated gradients, a reference input of all zeros was used.

To evaluate importance scores obtained by different methods, the following task was used: given an image that originally belongs to class cₒ, the pixels which should be erased to convert the image to some target class c, can be identified. This can be done by finding Sₓ_{ᵢ}_{diff}=Sₓ_{ᵢ}_{c}_{ₒ}−Sₓ_{ᵢ}_{c}_{ₜ} (where Sₓ_{ᵢ}_{c} is the score for pixel xᵢ and class c) and erasing some number of pixels (eq: up to 157 pixels which is 20% of the image) ranked in descending order of S_{diff} for which S_{diff}>0. The change in the log-odds score between classes cₒ and cₜ for the original image and the image with the pixels erased can then be evaluated.

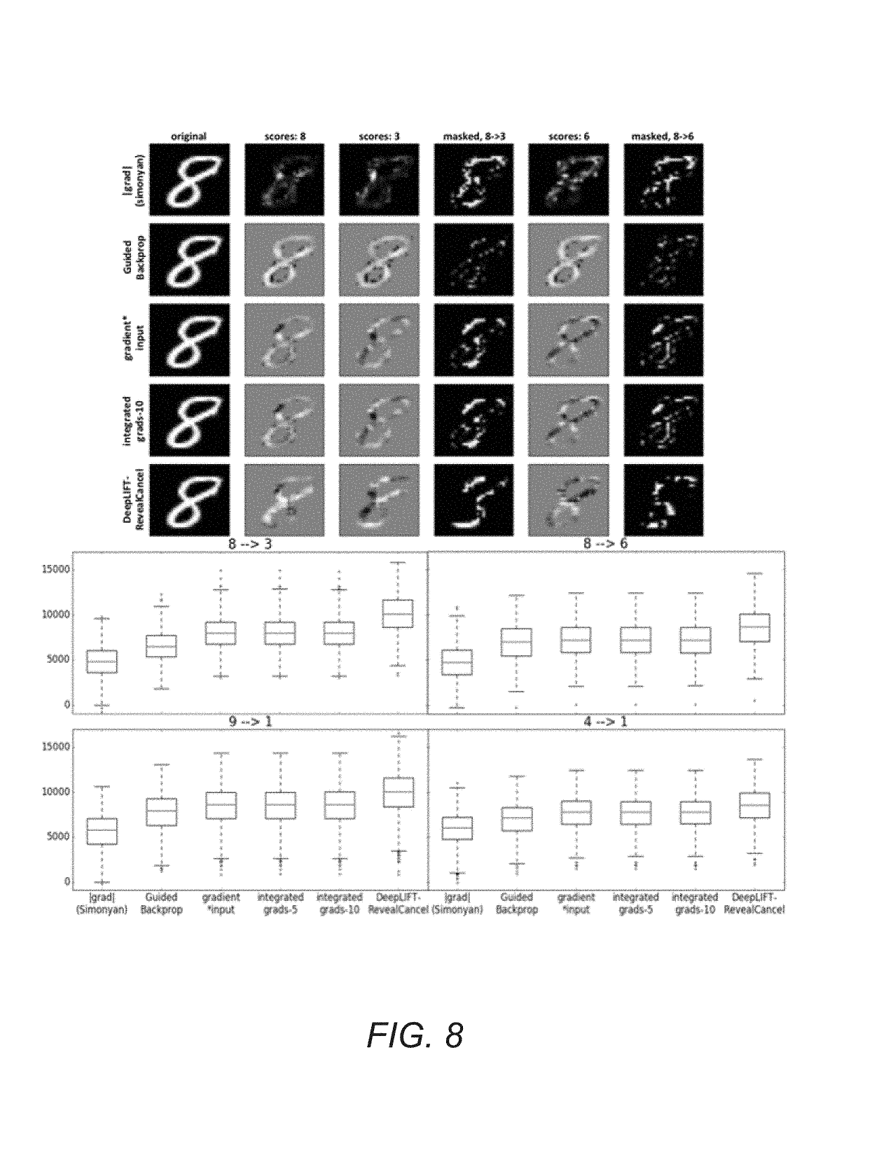

As illustrated in FIG. 8, DeepLIFT processes outperformed the other backpropagation-based approaches. Integrated gradients computed numerically over either 5 or 10 intervals produced comparable results to each other, suggesting that adding more intervals would not change the result. Integrated gradients also performed comparably to gradient*input, suggesting that saturation and thresholding failure modes are not common on MNIST data. Guided Backprop discards negative gradients during backpropagation, perhaps explaining its poor performance at discriminating between classes. FIG. 8 illustrates identifying pixels that are more important for a specific class compared to some other class, and compares a DeepLIFT process with various other approaches on the MNIST handwritten digit database. A DeepLIFT process in accordance with an embodiment of the invention better identifies pixels to convert one digit to another. Top: result of masking pixels ranked as most important for the original class (8) relative to the target class (3 or 6). Importance scores for class 8, 3 and 6 are also shown. The selected image had the highest change in log-odds scores for the 8→6 conversion using gradient*input or integrated gradients to rank pixels. Bottom: boxplots of increase in log-odds scores of target vs. original class after the mask is applied, for 1K images belonging to the original class in the testing set. “Integrated gradients-n” refers to numerically integrating the gradients over n evenly-spaced intervals using the midpoint rule.

DeepLIFT Processes with Genomics

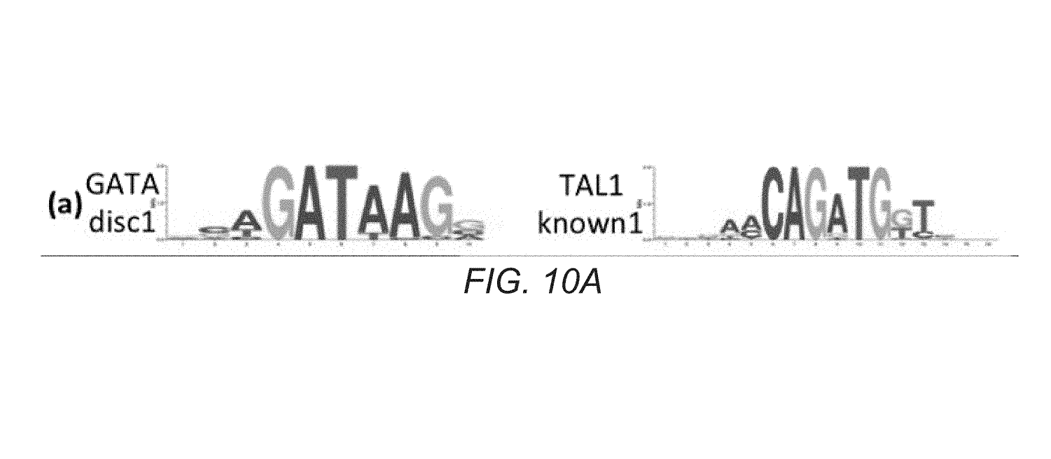

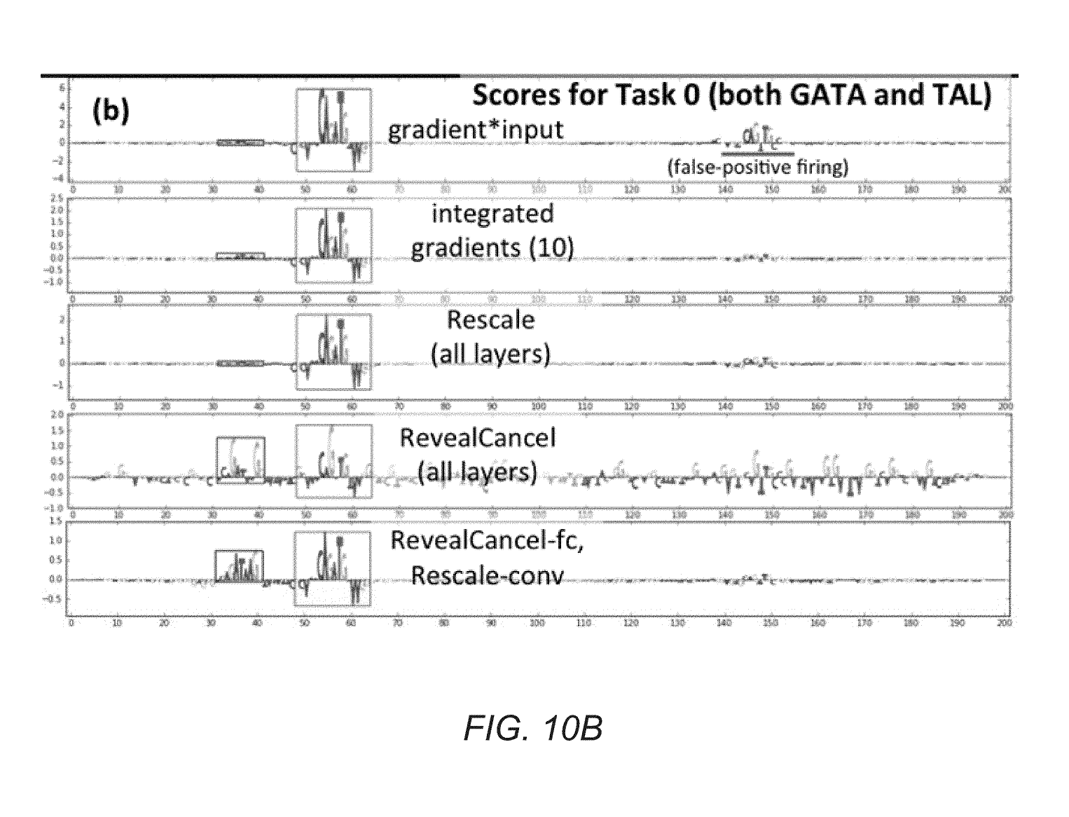

In several embodiments of the invention. DeepLIFT processes can be used on genomics datasets, either obtained biologically or through simulations. As an illustrative example of a simulation, background genomic sequences were sampled randomly with p(A)=p(T)=0.3 and p(G)=p(C)=0.2. DNA patterns were sampled from position weight matrices (PWMs) for the GATA_disc1 and TAL1_known1 motifs (FIG. 10A) from ENCODE, and 0-3 instances of a given motif were inserted at random non-overlapping positions in the background sequence. A 3-task classification simulation in accordance with an embodiment of the invention was trained with task 1 representing “both GATA and TAL”, task 2 representing “GATA” and task 3 representing “TAL”. ¼ of sequences had both GATA and TAL motifs (labeled 111). ¼ had only GATA motifs (labeled 010). ¼ a had only TAL motifs (labeled 001), and ¼ had no motifs (labeled 000). For DeepLIFT processes and integrated gradients, a reference input that had the expected frequencies of ACGT at each position was used (i.e. the ACGT channel axis was set to 0.3, 0.2, 0.2, 0.3 at each position). For fair comparison, this reference was also used for gradient x input and Guided Backprop×input (“input” is more accurately called Δinput where Δ measured w.r.t the reference). For genomics (unlike MNIST), Guided Backpropx input was used because it found to perform better than just Guided Backprop.

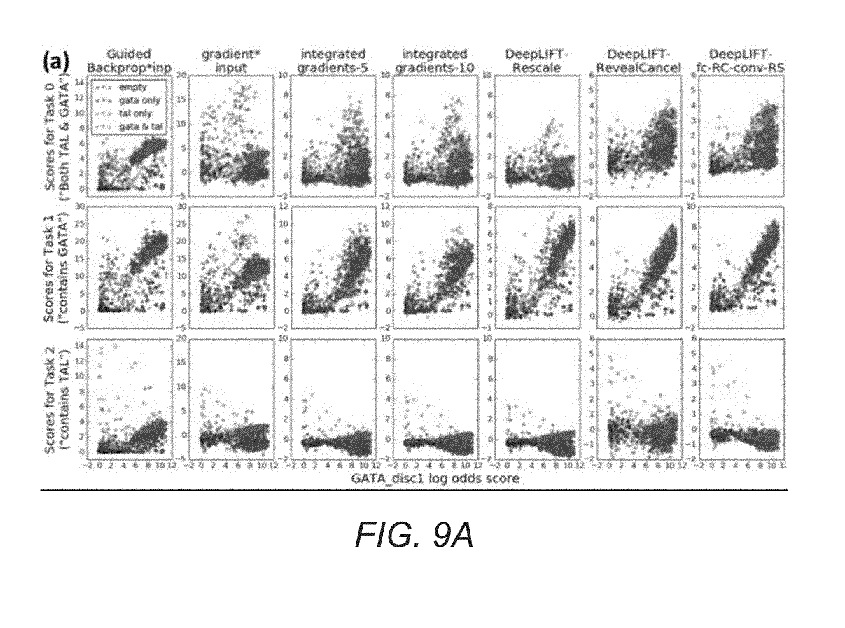

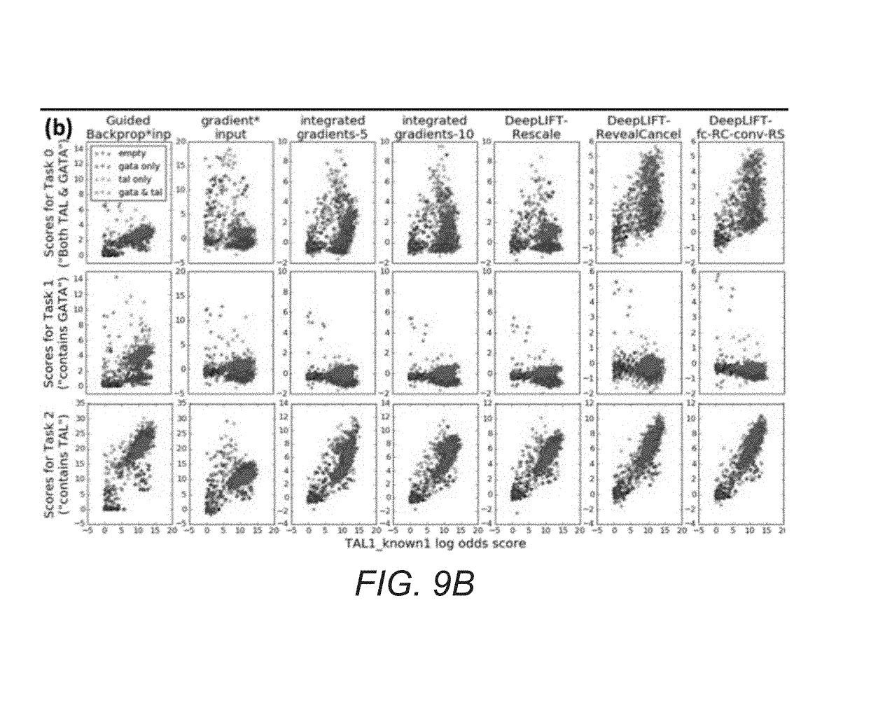

FIGS. 9A and 9B illustrate simulated DeepLIFT processes compared to other approaches applied to a sample genomics dataset. DeepLIFT processes give qualitatively desirable importance score behavior on the TAL-GATA simulation. X-axes: log-odds score of motif vs. background on subsequences (part (a) has log-odds for GATA_disc1 and (b) has scores for TAL_disc1). Y axes: total importance score over the subsequence for different tasks and methods. Red dots are from sequences where both TAL and GATA were inserted during simulation; blue is GATA-only, red is TAL-only, black has no motifs inserted. “DeepLIFT-fc-RC-conv-RS” refers to using the RevealCancel rule on the fully-connected layer and the Rescale rule on the convolutional layers, which appears to reduce noise relative to using RevealCancel on all the layers.

In accordance with an embodiment of the invention, given a particular subsequence, it is possible to compute the log-odds score that the subsequence was sampled from a particular PWM vs. originating from the background distribution of ACGT. To evaluate different importance-scoring methods, the top 5 matches (as ranked by their log-odds score) to each motif for each sequence from the test set can be found, as well as the total importance allocated to the match by different importance-scoring methods for each task. The results are shown in FIGS. 9A and 9B. Ideally, an importance scoring method to show the following properties is expected: (1) high scores for GATA motifs on task 1 and (2) low scores for GATA on task 2, with (3) higher scores corresponding to stronger log-odds matches; analogous pattern for TAL motifs (high for task 2, low for task 1); (4) high scores for both TAL and GATA motifs for task 0, with (5) higher scores on sequences containing both kinds of motifs vs. sequences containing only one kind (revealing cooperativity; this corresponds to red dots lying above blue/green dots in FIGS. 9A and 9B.

It can be observed that Guided Backprop×input fails properties (2) by assigning positive importance to GATA on task 2 and TAL on task 1. It fails property (4) by failing to identify cooperativity in task 0 (red dots overlay blue/green dots). Both Guided Backprop×input and gradient x input show suboptimal behavior regarding property (3), in that there is a sudden increase in importance when the log-odds score is around 6, but little differentiation at higher log-odds scores (by contrast, the other methods show a more gradual increase in importance with an increase in log-odds scores). As a result. Guided Backprop×input and gradient×input can assign unduly high importance to weak motif matches as illustrated in FIG. 10. This is a practical consequence of the thresholding problem. The large discontinuous jumps in gradient are also why they have inflated scores relative to other methods.

FIG. 10 illustrates importance scores assigned to an example sequence for Task 0. Letter height reflects the score. The Blue box is the location of an embedded GATA motif, and the green box is the location of an embedded TAL motif. The red underline is a chance occurrence of a weak match to TAL (CAGTTG instead of CAGATG). Both TAL and GATA motifs should be highlighted for Task 0.

In accordance with many embodiments of the invention, several versions of the DeepLIFT process were explored on the same simulated genomics data: one with the Rescale rule used at all nonlinearities (DeepLIFT-Rescale), one with the RevealCancel rule used at all nonlinearities (DeepLIFT-RevealCancel), and one with the Rescale rule used at the convolutional layers and RevealCancel used at the fully connected layer (DeepLIFT-fc-RC-conv-RS). In contrast to the results on MNIST, it was found that DeepLIFT-fc-RC-conv-RS reduced noise relative to DeepLIFT-RevealCancel.

Gradient×inp, integrated gradients and DeepLIFT-Rescale occasionally miss relevance of TAL or GATA for Task 0 (red dots near y=0 despite high log-odds—particularly for the TAL motif), which is corrected by using RevealCancel on the fully connected layer (see example sequence FIG. 10). Gradient×input, integrated gradients and DeepLIFT-Rescale also show a slight tendency to misleadingly assign positive importance to GATA for task 0 and TAL for task 1 when both GATA and TAL motifs are present in the sequence (red dots drift above the x-axis).

### Extensions for DeepLIFT Processes

In some embodiments of the invention, DeepLIFT processes can be extended in various ways including (but not limited to) using multipliers instead of original scores, combining scores, identifying scores as mediated through particular neurons, using DeepLIFT in conjunction with other importance based processes, and/or restriction of analysis to the validation set. These extensions will be discussed below.

Using Multipliers Instead of Original Scores.

In some embodiments, the values for the multipliers m_{ΔxΔt} are useful independently of the contribution scores themselves. For example, if a user is interested in what the contribution would be if the neuron x were to take on the value x′ instead of the reference, they can roughly estimate this as m_{ΔxΔt}(x′−x⁰), where x⁰ is the reference used DeepLIFT process. As an illustrative example, assume x represents an input to the neural network where the input is one-hot encoded (meaning that x is associated with a set of inputs such that only one of the inputs may be 1 and the rest must be 0), and that x is zero in the present input, but the user is interested in what the contribution would be if x were 1. If the reference used for the DeepLIFT process is zero (which can be appropriate if all one hot encoded inputs are equally likely and the normalization for constrained inputs has been applied), the user can simply look at the value of mₓₜ to obtain an estimate of this. In many embodiments, m_{ΔxΔt}(x′−x⁰) can be named phantom contribution scores where x⁰ is the reference used for the DeepLIFT process.

Combining Scores.

In several embodiments of the invention, it is possible to combine the scores for different target output neurons t to obtain discriminative scores for how much a particular target neuron is preferentially activated over another. For example, C_{ΔxΔt}_{₁}−C_{ΔxΔt}_{₂} can be interpreted as preferential contribution score to t₁ over t₂, especially if t₁ and t₂ are both neurons in the same softmax layer.

Identifying Scores as Mediated Through Particular Neurons.

Under some circumstances, generating contribution scores while ignoring any contributions that pass through a subset of neurons S is of interest. Setting m_{ΔxΔt}=0 if xεS during backpropagation can prevent any contribution from propagating through them.

In Conjunction with Another Importance-Score Process.

DeepLIFT processes can be used in conjunction with another importance-score process, which may be particularly appealing if the other process is more computationally intensive. For example, when applied to genomic data, DeepLIFT can rapidly identify a small subset of bases within a sequence might substantially influence the output of the classification if perturbed, which can subsequently be perturbed using in-silico mutagenesis or some other computationally intense method to exactly quantify the effect they have on the classification output

Restricting Analysis to the Validation Set.

If a neural network is trained on some training data t, it may be desirable to analyze the scores from DeepLIFT processes using only data from the examples that the process has not directly observed, such as data from the validation set; this may under some conditions produce superior results, likely because one is less likely to observe contribution scores that are due to overfitting, and more likely to observe contribution scores that are indicative of a true signal.

Holistic feature extraction processes to identify features in a neural network are discussed below.

### Holistic Feature Extraction Processes

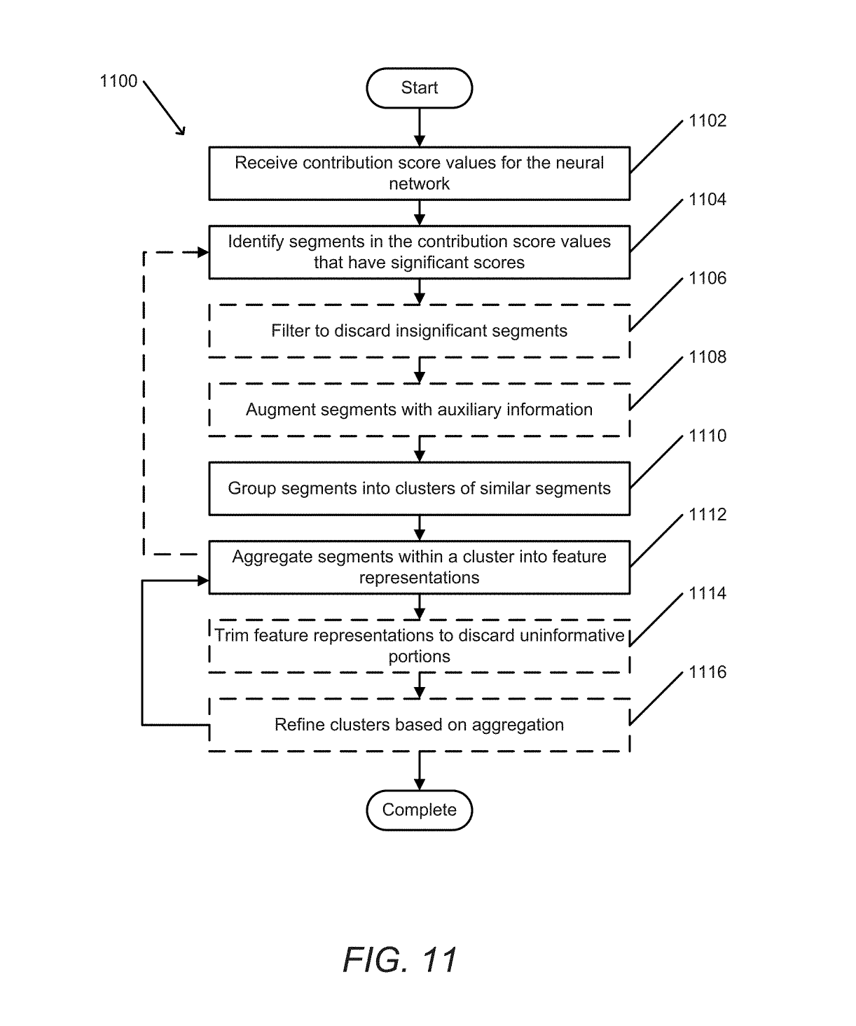

Holistic feature extraction processes in accordance with various embodiments of the invention are illustrated in FIG. 11. Process 1100 illustrates receiving (1102) contribution score parameters for a neural network. In some embodiments, these contributions score parameters can be calculated using DeepLIFT processes as described above, but other methods can be used as appropriate to the requirements of specific applications. Segments can be identified (1104) in the contribution score parameters that have significant scores. A variety of metrics can be used to rank significant scores including (but not limited to) highest scoring, lowest scoring, peak detection and/or outliers according to a statistical model such as a Gaussian model. Identifying significant segments in contribution score parameters is discussed in detail below.

In several embodiments, segments can optionally be filtered (1106) to discard insignificant segments. Segments can optionally be augmented (1108) with auxiliary information which can include (but is not limited to) phantom contribution scores, scores for different target neurons, raw values of the neurons in the segment and/or the scores/values of the corresponding location of the segment in layers above or below the layer(s) from which the segment was identified (applicable if the segment can be identified using data from a specific set of layer(s), which can include the input layer).

Segments can be grouped (1110) into clusters of similar segments. Mixed-membership models can be used to allow a segment to have membership in more than one cluster. In some embodiments of the invention, existing databases of features and/or current domain knowledge can be used when clustering segments, but segments can be clustered without using prior knowledge. Clustering segments will be discussed in detail below. In various embodiments, segments within a cluster can be aggregated (1112) to generate feature representations. Aggregating segments within a cluster into features is discussed in detail below.

Various post processing can occur on aggregated segments within a cluster once feature representations are identified. Feature representations can optionally be trimmed (1114) to discard uninformative portions. In many embodiments, clusters can optionally be refined (1116) based on aggregation results. Additionally, post processing can iteratively repeat on the aggregated results. Although many different feature extraction processes are described above with reference to FIG. 11, any of a variety of processes to aggregate and extract significant features from a neural network can be utilized as appropriate to the requirements of specific applications in accordance with embodiments of the invention. Details of holistic feature extraction processes are discussed below.

In several embodiments, holistic feature extraction processes can take input-specific neuron-level scores, either obtained through processes similar to DeepLIFT processes or by some other methods, and can identify aggregated features, or “patterns”, that emerge from those scores.

Holistic feature extraction processes can contain the following sub-parts: A segmentation process to identify the segments of a given set of inputs that have significant scores (where “significant” can be defined by a variety of methods, including but not limited to being unusually high and/or unusually low).

Illustrative segmentation processes are discussed, but it should be obvious to one having ordinary skill in the art that any of a variety of other segmentation processes can be utilized as appropriate to specific requirements of the invention. First, all possible segments within the input that satisfy some specified dimensions can be identified, and the segment for which the importance scores satisfy some criterion can be kept, such as (but not limited to) having the highest sum. In some embodiments, only those segments whose contribution are at least some specified fraction of the contribution of the highest segment can be retained. The process can then be repeated iteratively, with the optional modification that segments identified in subsequent iterations cannot overlap or be proximal to segments identified in previous iterations by more than a specified amount. Identified segments can also be expanded to include flanking regions before being supplied to subsequent steps of the holistic feature extraction process.

Second, a segmentation process can preprocess a signal of the scores of the input using a smoothing algorithm such as (but not limited to) additive smoothing, Butterworth filters, exponential smoothing, Kalman filters, kernel smoothing, Kolmogorov-Zurbenko filters, Laplacian smoothing, local regression, low-pass filters, moving averages, smoothing splines, and/or stretched grid methods. The scores (with or without preprocessing) can be used as an input into a peak-finding process to identify peaks in the scores, and the segments corresponding to the peaks, which can be of variable sizes, can be used as the input to subsequent steps of the holistic feature extraction processes.

Third, a segmentation process can fit statistical distributions to identify significant segments. An illustrative example would be fitting a Gaussian mixture model or a Laplace mixture model with three modes to identify inputs with low, average or high importance scores. Such a mixture model can be fit to a variety of values, including (but not limited to) raw scores, scores from smoothed windows of arbitrary length, or transformed scores such as the absolute value to obtain more robust statistical estimates. Following the fitting of a statistical distribution, segments can be determined as those portions of the input that have higher likelihood of belonging to the low and high scoring distributions than the average distribution. Additional extensions include (but are not limited to) using only segments that score as significant in models fit to smoothed scores as well as models fit to raw scores.

Holistic feature extraction processes in accordance with various embodiments can optionally include a filtering step to discard segments deemed to have insignificant contribution. An example of such a filtering step includes (but is not limited to) discarding any segments whose total contribution is below the mean contribution of all segments.

Additionally, many embodiments of the invention can include optional augmentation, which can augment the segments with auxiliary information. Some examples of auxiliary information can include (but are not limited to) phantom contribution scores described above, scores for different target neurons, raw values of the activations of neurons in the segment and/or the scores/activations of the corresponding location of the segment in layers above or below the layer(s) from which the segment was identified (applicable if the segment can be identified using data from a specific set of layer(s)). For instance, if the segment was identified from zero-indexed positions i to i+l in a convolutional layer with kernel width w and stride s, and augmented data from the layer below was used, the corresponding indices in the layer below would be (si) to (s(i+l)+w).

Holistic feature extraction processes in accordance with several embodiments of the invention can use clustering processes to group the segments and their auxiliary information (if any) into clusters of similar segments. This clustering process may take advantage of existing databases of features to structure clusters with current domain knowledge.

As an illustrative example where domain knowledge is not incorporated, a clustering process can take a specific set of data tracks corresponding to each segment, which may or may not include data from one or more auxiliary tracks, apply one or more normalizations (including but not limited to subtracting the mean and dividing by the euclidean norm of each data track), and then using a metric, such as the maximum cross correlation, between normalized data tracks form two separate segments as the distance metric. As another illustrative example, in the case where the underlying data is character-based, a clustering process can use information about the occurrences of substrings in the underlying sequence (in the context of genomics, these would be called k-mers), with or without gaps or mismatches allowed, to determine overrepresented patterns and cluster segments together. These substrings could optionally be weighted according to the strength of the scores overlaying them, where scores can be generated by a variety of processes such as (but not limited to) DeepLIFT processes

Instead of computing the distance between two segments directly, the vector of distances between a segment and some third-party set of representative patterns (where the representative patterns can be obtained through methods including but not limited to using prior knowledge or unsupervised learning) can be found. The distance between the two segments can be defined as a distance (which could include but is not limited to euclidean distance or cosine distance) between the vectors of distances to the third-party set of representative patterns.

An alternative illustrative example of clustering processes for holistic feature identification can incorporate domain knowledge. Features can be taken from an existing database and metrics such as (but not limited to) those described under feature location identification processes can be used to compare and assign segments to database features. In many embodiments, a segment can be assigned to more than one feature. In some embodiments, features from the database can be transformed prior to comparison. An example transformation includes (but is not limited to) taking an existing database of DNA motif Position Weight Matrices (PWMs) and taking the log odds compared to a background rate of nucleotide frequencies.

In some embodiments, these database features with similar assignments of segments can be merged together and clustering processes can be repeated using merged features. Clustering processes can be iteratively refined in this way. Furthermore, to more meaningfully associate a given learned feature with a known feature, the learned feature may be shuffled or perturbed to create a distribution of scores encountered by chance between unrelated features that true values can be compared to. In genomics, one example of this perturbation would be dinucleotide shuffling. Additionally, learned features that do not match any known features can be analyzed using a process that does not incorporate domain knowledge.

Clustering processes can include normalizations such as (but not limited to) normalizing by the mean and standard deviation, and/or normalizing by the Euclidean norm. In some embodiments, it can be possible to normalize by a different value at every position at which the cross correlation is done by, for instance, dividing by the product of the Euclidean norms of the portions of the segments that are overlapping at that position of the cross-correlation (which would give the cosine distance between the overlapping segments). Note that the normalization may be applied to each track individually and/or to the concatenated tracks as a whole. Similarly, cross correlation may be performed for each data track individually or to the concatenated tracks as a whole.

In some embodiments, multiple data tracks can be of different lengths. In such embodiments, cross-correlation can involve increasing the cross correlation stride for the longer tracks to match the equivalent shorter stride for the shorter tracks. For example, if track A is twice the length of track B, on track B when one position is slid over, two positions will be slid over on track A. In several embodiments, this can be effectively accomplished by inserting zeros at every alternate position of track B to make it the same length as track A and a step size of 2 can be taken during the cross correlation. Furthermore, flanks may be padded according to an appropriate constant to account for partial overlaps during cross correlation.

In various embodiments, a distance matrix between segments can be supplied to a clustering processes such as (but not limited to) spectral clustering, louvain community detection, phenograph clustering, dbscan clustering and k-means clustering. Additionally, a new distance matrix can be generated by leveraging a distance between the rows of the original distance matrix, including but not limited to the Euclidean distance or cosine distance. The number of clusters can be determined by a variety of methods including (but not limited to) by Louvain community detection, by eye according to a t-sne plot, and/or by using heuristics such as BIC scores or silhouette scores. In some embodiments, a method such as t-sne or PCA is used as a pre-processing step to the clustering.

Various strategies for noise-reduction of the distance matrix can be employed. For example, stronger edges can be assigned to nodes that have similar weights to all other nodes in the graph. An example of a refinement of the distance matrix is given below:

$${e}_{xy}^{′} = \frac{{\sum }_{t} min ( {e}_{xt} , {e}_{yt} )}{{\sum }_{t} max ( {e}_{xt} , {e}_{yt} )} \qquad ( 9 )$$

where e′_{xy} is the new edge weight between x and y, ea is the original weight between x and t, and t iterates over all the nodes in the graph. Another example is the Jaccard distance between k-nearest neighbours, similar to what is employed in Phenograph clustering. In some embodiments, such refinements can be applied iteratively.

Furthermore, unsupervised learning can also be used to aid clustering processes. An example of such unsupervised learning includes (but is not limited to) a convolutional autoencoder that learns a low-dimensional representations of the segments that may be easier to cluster, or a variational autoencoder on a vector of scores representing the strengths of the match of the segment to some pre-defined set of patterns (such a vector of scores can be obtained by methods that include but are not limited to the feature location identification processes described below). The autoencoders may involve regularization to encourage sparsity. In some embodiments, the objective function of a convolutional autoencoder can be modified to reward correct reconstruction of true segments and penalize correct reconstruction of segments identified randomly, thereby encouraging the autoencoder to learn patterns that are unique to the true segments. In some embodiments, a further modification of the objective function can be to only compute the loss on some portion of the segment that had the best reconstruction loss. Such a modification can be motivated by the fact that only a portion of the segment might contain true signal and the rest might contain noise. In some embodiments, the weights of the decoder may be tied to the weights of the encoder if the appropriate weights of the decoder can likely be deduced from the weights of the encoder. This weight-tying can be motivated by the fact that reducing the number of free parameters can often improve the performance of machine learning models.

As discussed above, clustering processes can be iteratively refined. An example includes (but is not limited to) using prior knowledge of what the clusters may look like to aid in clustering. The prior expectations of how the clusters should look can then be replaced using the patterns output by the clustering process. In this way, the prior knowledge can be refined with iterative improvement.

In some embodiments, segments can be further subclustered within each cluster to find further information. Examples include (but are not limited to) using subclusters as identified by Louvain community detection, or subclustering using k-means with a number of subclusters determined by a silhouette score.

In various embodiments, holistic feature extraction processes can include aggregation processes to aggregate segments within a cluster into unified “features”. In many embodiments, an “aggregator” can track the aggregated feature and combine identified segments. Furthermore, for each position in the resulting aggregated feature, the aggregator can keep count of how many underlying segments contributed to that position. The aggregator can be initialized according to the data in a well-chosen segment. For example (but not limited to), this could be the highest-scoring segment in the cluster.

The optimal alignment can be found for every segment with the aggregated feature according to what results in the maximum cross correlation (possibly using data from one or more auxiliary tracks, and possibly after one or more normalizations as described earlier). The values from each data track in each segment can be added according to this optimal alignment to their respective data tracks in the aggregator. In some embodiments, the position that each segment aligned to can be recorded, and this information can (in some embodiments) be used to determine whether the aggregated feature consists of segments aligning predominantly to more than one center (which could suggest a need for subclustering) or whether there is likely a single unified center. Note that other kinds of aggregation, such as taking the product instead of the sum, are also possible.

In various embodiments, the aggregated values of all segments in the aggregator can optionally be normalized at each position according to the count underlying that position. This normalization may or may not include a pseudocount, and the specific value of the pseudocount may depend on the specific kind of data track. In several embodiments, segments in the aggregator can be normalized by other ways including (but not limited to) weighted normalization by taking a weighted sum of the contributions at a particular position, where the weights may be derived in a variety of ways, such as by looking at the confidence of the prediction for a particular example.

Alternative aggregators can be used as appropriate to requirements of specific embodiments of the invention. Examples include (but are not limited to) using aggregators that rely on hierarchical clustering of the segments to determine the order in which segments should be aggregated (i.e. the most similar segments can be aggregated together first, and subclusters of aggregated segments can be optionally merged according to a threshold of similarity). Another example includes (but is not limited to) taking advantage of existing processes for multiple alignment to first align segments before aggregating them. In some embodiments, an aggregator could also be tasked with aligning segments such that insertions or gaps are allowed as part of the alignment, such as when describing patterns that can contain variable amounts of spacing.

Holistic feature extraction processes can optionally use trimming processes. Trimming processes can take aggregated features and discard uninformative portions. Examples can included (but are not limited to): trimming to only those positions where the total number of segments supporting the position is at least some specified fraction of the maximum number of segments supporting any position, trimming to a segment of fixed length that has the highest total score, and/or trimming to a segment which contains at least a fixed percentage of the total score.

Additionally, clusters obtained during holistic feature extraction processes can further be refined. Examples include but are not limited to subclustering the clusters to identify featured at finer granularity, merging clusters together if it appears that the clusters are sufficiently similar based on the distances between the clusters (where the method of computing distance can include but is not limited to looking at the distances between individual segments within one cluster and individual segments within another cluster), and determining whether a given cluster is likely to be the product of statistical noise using methods including (but not limited to) quantifying the distances between segments within a single cluster (clusters that are the product of statistical noise can often have larger within-cluster distances than clusters that represent genuine features). Additionally, steps within holistic feature extraction processes can be repeated iteratively such as (but not limited to) iteratively repeating aggregation and/or trimming.

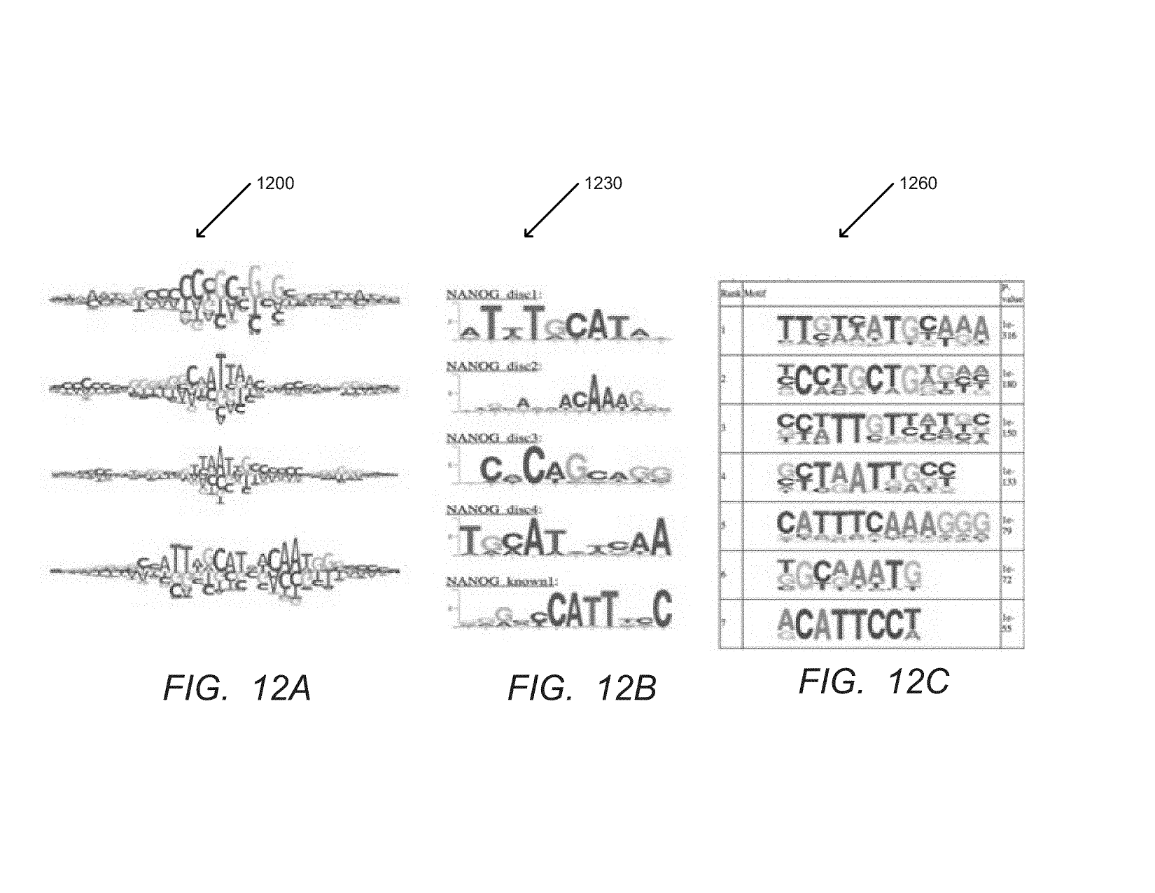

FIGS. 12A-12C illustrates broader and more consolidated patterns in genomic data identified using holistic feature extraction processes compared to existing methods. A Convolutional Neural Network was trained to predict the binding of the Nanog protein. FIG. 12A illustrates aggregated multipliers at four segment clusters identified by holistic feature extraction processes using DeepLIFT scores, where maximum cross-correlation between segments normalized using the mean and standard deviation was used as the distance metric and t-sne followed by spectral clustering was used to identify clusters. Occurrences of the patterns are indicative of the binding of the Nanog protein. FIG. 12B illustrates patterns identified by the ENCODE consortium for Nanog using the same data. FIG. 12C illustrates 7 of 32 patterns identified by running HOMER on the same data. The patters found in FIG. 12A by holistic feature extraction processes contain much less redundancy and are much broader than those found by either alternative method as shown in FIGS. 12B and 12C.

### Feature Location Identification Processes

In some embodiments of the invention, feature identification processes can use feature representations to identify specific occurrences of a feature elsewhere, such as (but not limited to) in an given set of input data. In many embodiments of the invention, feature representations can be identified using importance scores (such as those obtained from a neural network) using a holistic feature extraction process similar to a process described above, but other methods and/or combinations of methods can be used to extract features as appropriate, including but not limited to using pre-defined features from a database of features such as PWMs.

In some embodiments, a particular input can be scored for potential match locations to each feature. i.e. potential hit scoring. This can be done by leveraging the various data tracks associated with an aggregated feature, possibly including auxiliary data tracks, and comparing them to the relevant data tracks from the provided inputs.

Variations of potential hit scoring can include (but are not limited to): a. For one-hot encoded data, it is possible to use the mean frequency of the aggregated raw data as a position-weight-matrix, since the proportions at each position can be interpreted as the probability of seeing a ‘1’ at that position. The log of the position weight matrix can then be cross correlated with the raw input track to get an estimate of the log probabilities of observing the input at each location. The log PWM can be normalized to account for the background frequencies of the various characters represented by the one-hot encoding.

b. It is possible to use cross-correlation between some set of data tracks corresponding to each feature (including but not limited to those obtained by aggregating various data tracks during the aggregation step of a process similar to a the holistic feature extraction process described above) and the raw input. If the score tracks used in the cross correlation are score tracks of DeepLIFT multipliers, and the input is normalized by subtracting the reference, this can be interpreted as an estimate of the DeepLIFT contribution score of the input.

c. It is also possible to cross correlate one or more aggregated data tracks belonging to the feature with one or more data tracks associated with a given input. This may be done with or without various normalizations, such as dividing the result of the cross correlation at each position by the Euclidean norm of overlapping segments (which results in an interpretation as a cosine distance of the overlapping segments).

d. Another potential distance metric to use when scoring hits is to use a product of cosine distances. An example includes (but is not limited to): given an aggregated data track of multipliers for the feature, a corresponding data track of multipliers for an input, and the raw input, one could compute the cosine distance at each position between the aggregated multipliers and the multipliers of the input, as well as the cosine distance between the aggregated multipliers and the raw input (an example of raw input includes but is not limited to one-hot encoded sequence input for genomic data). By taking the product of these cosine distances as the final distance metric, one can inherit the advantages of using each cosine distance individually. Another example includes (but is not limited to) taking the cosine distance of the log-odds scores of a known PWM with a data track of phantom contribution scores for an input and multiplying by the cosine distance between the log-odds score of the known PWM and the one-hot encoded sequence input. An example of phantom contribution scores includes but is not limited to the phantom contributions of having either A, C, G, or T present at a particular position in the input. In some embodiments, one can leave out constant normalization terms from the computation of a cosine distance (including but not limited to normalization by the magnitude of a PWM) and obtain distances that produce an equivalent ranking of matches.

e. Another example, applicable to constrained input such as one-hot encoded input, involves cross correlating the multipliers as in c, but multiplying this by the ratio of the total contribution of the cross correlated segment (as estimated by a process for assigning importance scores including but not limited to DeepLIFT) to the estimated maximum possible contribution of the segment. The maximum possible contribution of a constrained input can be estimated using the multipliers by finding the setting of the input that would result in the highest contribution according to the multipliers. For example, for one-hot encoded input where the reference is all zeros, this may be obtained by taking the maximum multiplier within each one-hot encoded column and summing the resulting maximums across the columns.

Feature location identification processes additionally can optionally include hit identification to discretize the scores if the scores are continuous and not discrete. In many embodiments, various approaches can be used to discretize scores including (but not limited to) fitting a mixture distribution, such as a mixture of Gaussians, to the scores to determine which scores likely originated from the “background” set and which scores likely originated from true matches to the feature; a threshold can then be chosen according to the desired probability that a score originated from a true match to the feature.

A feature location identification process in accordance with many embodiments of the invention may additionally work as follows: a small neural network can be designed consisting only of a subset of neurons that shows distinctive activity when fed a patch containing a feature of interest (“patch” is a general term that can refer to inputs of any shape/dimension). One method of designing such a network includes (but is not limited to): starting from patches that aligned to a cluster containing a feature of interest during a process that can be similar to (but is not limited to) the holistic feature extraction processes described above and considering the activity of some neurons in higher-level layers of a neural network (often convolutional layers) where the neurons received some input from the feature. The neurons in this layer can then be subset according to strategies including but not limited to retaining only those neurons that show high variance in activity when fed patches containing the feature versus patches that don't contain the feature, or neurons that had high importance scores as could be calculated by a variety of processes (for example but not limited to DeepLIFT processes). In some embodiments, a secondary model (including but not limited to support vector machines, logistic regression, decision trees or random forests) can be designed using the activity of this smaller network in order to better identify the feature of interest. One example of a preliminary method of making the secondary model includes (but is not limited to) multiplying the difference-from-reference of the activity of the output neurons of the smaller network by multipliers identified using DeepLIFT processes.

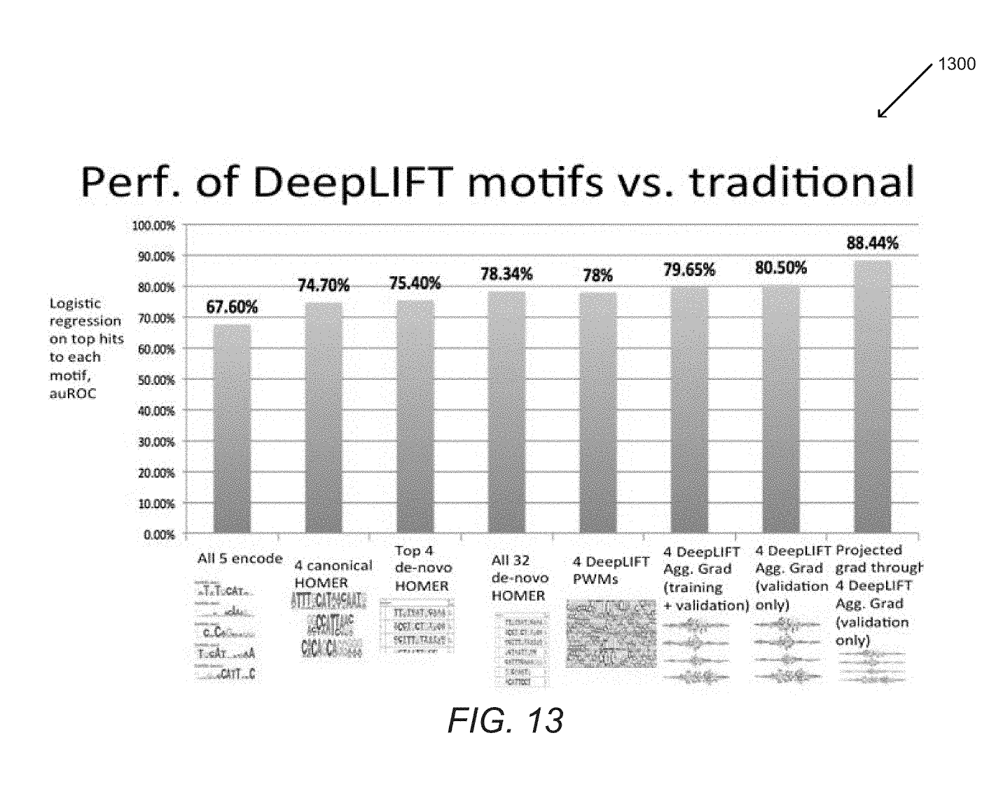

FIG. 13 illustrates simulated results for a feature identification process on genomic sequence where features were identified using a holistic feature extraction process, and compares the results to features obtained through other methods. In a simulated embodiment of the invention, a convolutional neural network was trained to predict the binding of the Nanog protein from genomic sequence data. Contribution scores were predicted using a DeepLIFT process as discussed above. Features were identified using a holistic feature extraction process as discussed above, once using only data from a validation set and once using data from both the training and validation set. Instances of the features were found using three variants of feature location identification processes. A logistic regression classifier was then trained to predict labels given the top three scores for each pattern per sequence. FIG. 13 illustrates the resulting performance simulated of logistic regression. Last four columns, left-to-right: features found on training+validation set and scored using cross-correlation of the one-hot encoded sequence with a log-odds matrix obtained from aggregated one-hot encoded segments, features found on training+validation set and scored using cross-correlation of the one-hot encoded sequence with aggregated multipliers, features found on validation set only and scored using cross-correlation of the one-hot encoded sequence with aggregated multipliers, and features found using only the validation set and scored with a product of the cosine distance between aggregated multipliers and the multipliers of the input sequence and the cosine distance between aggregated multipliers and the one-hot encoded sequence. The first 4 columns show the corresponding performance obtained by using log-odds scores for the top 3 matches per sequence to PWMs from various sources as features. Left-to-right: all 5 ENCODE PWMs, 4 curated PWMs from HOMER's database that most closely match PWMs found from the holistic feature extract process, top 4 PWMs found by running HOMER directly on data, and all 32 PWMs found by running HOMER directly on data.

### Interaction Detection Processes

In many embodiments of the invention, interaction detection processes can determine interactions between neurons within a neural network (recall that “neuron” can refer to an internal network neuron or to an input into the network). Input-specific score values for neurons, either computed using DeepLIFT processes and/or using some alternative process, may be used to derive interaction scores by investigating the changes in scores of some set of neurons when the activations of certain other neurons are perturbed. In several embodiments of the invention, these changes can be at individual neurons within the network and/or to the inputs of the network. Note too that a perturbation does not have to be performed to just a single neuron, but can be performed on collections of neurons, and a perturbation is not restricted to setting the activations to zero—for instance, one might investigate the effect of setting the activation of a neuron x to a default value such as Aₓ⁰, or might investigate the impact of turning on a different one-hot encoded input (which is the perturbation that is performed by in-silico mutagenesis).

It is also possible to arrive at interaction score values by identifying a subset of inputs whose contributions, as computed either using DeepLIFT processes or by some other method, can cause a particular target neuron to take on values of interest. As an illustrative example, consider a network with a sigmoidal output o and associated bias bₒ. The smallest subset of inputs S may be of interest such that (Σ_{xεS}Cₓₒ)+b>0.5 (in other words, the smallest subset of inputs required to trigger a classification of ‘1’ if the task is binary classification). As another illustrative example, assume a target neuron o is a ReLU with associated bias bₒ. All combinations C of inputs such that (Σ_{xεS}Cₓₒ)+b>0 may be of interest (in other words, all possible combinations of inputs that can result in an ‘active’ ReLU).

Finally, it is possible to arrive at interaction score values by looking at how the scores change when certain covariates are varied. Covariates can include aspects such as the activations or contribution-scores of another neuron or a group of neurons. For example, for multimodal input, one can investigate how the scores for one mode changes when the average activations or contributions of neurons in another mode are altered. If feature instances have been identified (by holistic feature extraction processes or some other method), it is possible to even use more abstract covariates such as the location of a feature within an input.

In several embodiments of the invention, there are many possible extensions and variants of interaction detection processes. Computing feature-level dependencies and computing intra-feature dependencies are described below.

Computing Feature-Level Dependencies.

If collections of neurons have been identified on an input-specific basis as belonging to “features”, either using feature identification processes or some other method (recall that “neuron” can refer to an internal network neuron or to an input into the network), it is possible to use this to compute feature-level dependencies by aggregating the scores within each feature and computing the change in the aggregated scores when certain perturbations are made or covariates are altered. Multiple methods of aggregation are possible, such as taking the sum or the max. During the aggregation, the scores from a feature instance may also be weighted according to the confidence associated with that feature instance (where the confidence scores may be obtained from feature identification processes or some other method). Note that the perturbations, too, can be performed on collections of neurons, such as all neurons belonging to a feature. Also note that these feature-level dependency scores can further be aggregated across different inputs to derive statistically meaningful relationships between the features.

Computing Intra-Feature Dependencies.

If collections of neurons have been identified on an input-specific basis as belonging to “features”, either using the output of algorithm 3 or some other method (recall, once again, that “neuron” here can refer to a network neuron or to the inputs into the network), it is further possible to use this to obtain translationally-invariant aggregate statistics for dependencies within features. As a concrete example, imagine a particular one-hot encoding pattern has been identified as a “feature”. For simplicity, assume there is only one instance of this pattern for every input. Let sᵢ represent the start position of this pattern for input i, and further assume the pattern is of length l. The dependency scores can be computed for all pairs of neurons from positions sᵢ to sᵢ+l, and this can be repeated for all inputs i. These dependency scores can then be aligned across all inputs i based on the location of the feature within each input, and aggregated after aligning to derive useful statistics on dependencies within a feature, where the specific aggregation method is flexible and may or may not involve weighing scores from a feature according to their confidence.

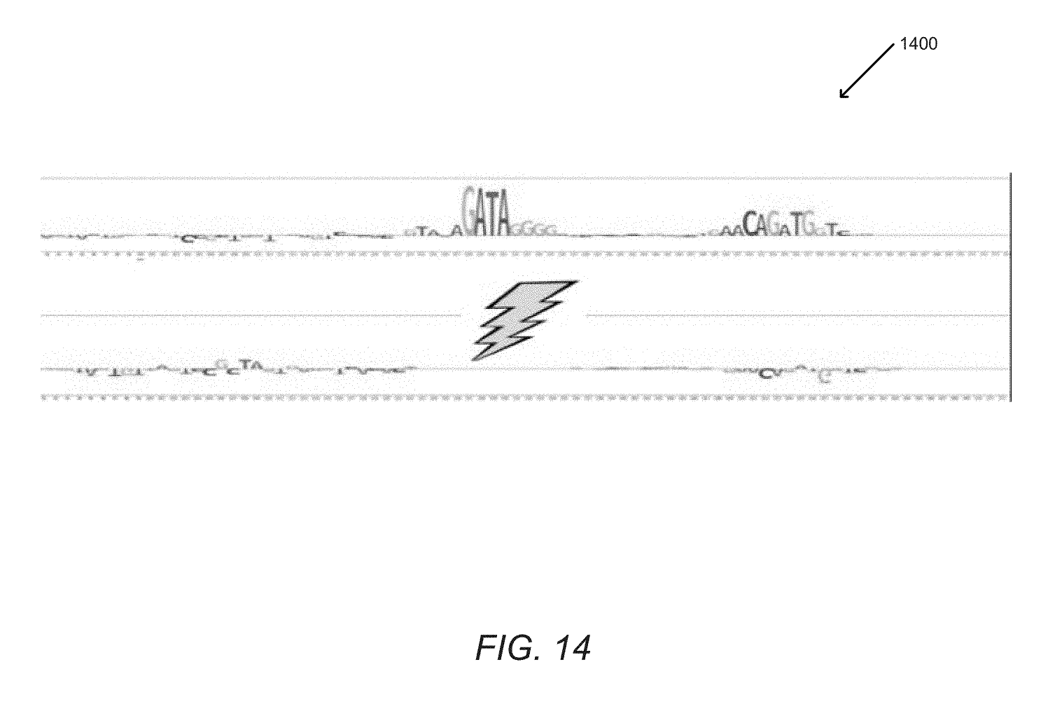

FIG. 14 illustrates dependencies between inputs as illustrated between simulated interaction detection processes. A convolutional neural network was trained to classify sequences containing both a GATAGGGG-like pattern and a CAGATG-like pattern as positive, and regions containing one or two instances of only GATAGGGG or only CAGATG as negative (sequence is one-hot encoded). The top track shows DeepLIFT scores on the original sequence. The bottom track shows the DeepLIFT scores when the strong GATAGGGG match is abolished (the inputs at those positions are set to their reference of zero: due to weight normalization of the first convolutional layer, this is a reasonable choice of a reference). In the absence of a strong GATAGGGG, the CAGATG-like pattern carries little weight.

### Weight Reparameterization Processes

In several embodiments of the invention, weight reparameterization processes can obtain a rough picture of the pattern of the response of a particular neuron. A neuron with an activation of the form Aₓ=f(Lₓ) can be considered, where Lₓ=(Σ_{wεI}_{ₓ}W_{wx}A_{w})+bₓ is a linear function of the inputs Iₓ to x. If f is monotonic, it can be shown that the vector of input activations {A_{w}: wεIₓ} of a fixed Euclidean norm which will result in a maximal or minimal value for Aₓ will be such that the ratios of {A_{w}: wεIₓ} equal the corresponding ratios of {W_{wx}: wεIₓ}. The solutions to such optimization problem for norms other than the Euclidean norm or for other types of activation functions can also be analytically computed.

A complication can arise when some set of neurons V is of interest where some or all of the neurons in V are not direct inputs of the neuron of interest x. If one wants to find the values of {Aᵥ: vεV} of a fixed norm that result in a maximum or minimum value for Aₓ, the solution can frequently be unsolvable analytically because there are typically one or more nonlinearities between neurons in V and x. For example, consider the case of a have a one-layer ReLU network following by a single sigmoidal output. Let V represent the input to the network and let o represent the sigmoidal neuron. If the settings of {Aᵥ: vεV} are desired that result in maximal or minimal activation of Aₒ, the ReLU nonlinearities of the first layer prevents the solution from being found analytically. However, an approximation can be found by simply replacing the ReLU nonlinearity with a linearity and finding the values of Wᵥₒ that satisfy Lₒ=(Σ_{vεI}_{ₓ}WᵥₒAᵥ)+b′ₒ in this altered network. These can be computed analytically and will generally have a solution, because a linear function of a linear function is a linear function. For example, for the simple network described, Wᵥₒ=Σ_{w}W_{vw}W_{wo} and b′ₒ=bₒ+Σ_{w}b_{w}W_{wo}. Once this reparameterization in terms of {Aᵥ: vεV} is computed, the maximally or minimally activating values for {Aᵥ: vεV} can be found using the strategies discussed in the preceding paragraph. In several embodiments of the invention, this reparametrization can be done for any kind of neuron, including for neurons in a convolutional layer.

Incorporating Importance Scores into the Training Procedure of a Neural Network

When there is prior knowledge about what features should be important, or what the distribution of importance scores should look like, a process like a DeepLIFT process (or some other importance score process) could be incorporated into the objective function used to train a neural network. As an illustrative example, if there is some prior knowledge of which locations in a DNA sequence, or words in a sentence, are likely to be important, a regularizer could be devised that rewards the network for assigning high importance scores to such locations/words. Alternatively, if for example it is known that only a small number of locations in a DNA sequence are likely to be important, the network could be penalized for assigning high importance to too many locations. If the importance scoring method is differentiable with respect to the input, a process incorporating such a regularizer could be trained using gradient descent.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A system for identifying informative features within input data using a neural network data structure, comprising:
a network interface;
a processor, and;
a memory, containing:
a feature application;
a data structure describing a neural network that comprises a plurality of neurons;
wherein the processor is configured by the feature application to:
determine contributions of individual neurons to activation of a target neuron by comparing activations of a set of neurons to their reference values, where the contributions are computed by dynamically backpropagating an importance signal through the data structure describing the neural network;
extracting aggregated features detected by the target neuron by:
segmenting the determined contributions to the target neuron;
clustering the segmented contributions into clusters of similar segments;
aggregating data within clusters of similar segments to identify aggregated features of input data that contribute to the activation of the target neuron; and
displaying the aggregated features of input data to highlight important features of the input data relied upon by the neural network.

2. The neural network data structure of claim 1, wherein the activation of the target neuron and the activations of the reference neurons are calculated by a rectified linear unit activation function.

3. The neural network data structure of claim 1, wherein the reference input is predetermined.

4. The neural network data structure of claim 1, wherein segmenting the determined contributions further comprises identifying segments with a highest value.

5. The neural network data structure of claim 4, wherein the processor is further configured to extract aggregated features by: filtering and discarding determined contributions with the significant score below the highest value.

6. The neural network data structure of claim 1, wherein the processor is further configured to extract aggregated features by: augmenting the determined contributions with a set of auxiliary information.

7. The neural network data structure of claim 1, wherein the processor is further configured to extract aggregated features by: trimming aggregated features of the target neuron.

8. The neural network data structure of claim 1, wherein the processor is further configured to extract aggregated features by: refining clusters based on the aggregated features of the target neuron.

9. The neural network data structure of claim 1, wherein the memory further contains input data and comprises a plurality of examples;
and the processor is further configured by the feature application to identify examples from the input data in which the aggregated features are present.

10. A method for identifying informative features within input data using a neural network data structure, comprising:
a network interface;
a processor, and;
a memory, containing:
a feature application;
a data structure describing a neural network that comprises a plurality of neurons;
wherein the processor is configured by the feature application to:
determining contributions of individual neurons to activation of a target neuron by comparing activations of a set of neurons to their reference values, where the contributions are computed by dynamically backpropagating an importance signal through the data structure describing the neural network;
extracting aggregated features detected by the target neuron by:
segmenting the determined contributions to the target neuron;
clustering the segmented contributions into clusters of similar segments;
aggregating data within clusters of similar segments to identify aggregated features of input data that contribute to the activation of the target neuron; and
displaying the aggregated features of input data to highlight important features of the input data relied upon by the neural network.

11. The method of claim 10, wherein the activation of the target neuron and the activations of the reference neurons are calculated by a rectified linear unit activation function.

12. The method of claim 10, wherein the reference input is predetermined.

13. The method of claim 10, wherein segmenting the determined contributions further comprises identifying segments with a highest value.

14. The method of claim 13, wherein the processor is further configured to extract aggregated features by: filtering and discarding determined contributions with the significant score below the highest value.

15. The method of claim 10, wherein the processor is further configured to extract aggregated features by: augmenting the determined contributions with a set of auxiliary information.

16. The method of claim 10, wherein the processor is further configured to extract aggregated features by: trimming aggregated features of the target neuron.

17. The method claim 10, wherein the processor is further configured to extract aggregated features by: refining clusters based on the aggregated features of the target neuron.

18. The method claim 10, wherein the memory further contains input data and comprises a plurality of examples;
and the processor is further configured by the feature application to identify examples from the input data in which the aggregated features are present.
